(19) United States
(12) Patent Application Publication
(10) Pub. No.: US 2013/0334120 A1
(43) Pub. Date: Dec. 19, 2013

(54) FLUID CLEANSING DEVICES AND METHODS OF USE

(71) Applicant: President And Fellows Of Harvard College, Cambridge, MA (US)

(72) Inventors: Donald E. Ingber, Boston, MA (US); Joo Hun Kang, Boston, MA (US); Richard C. Terry, Carlisle, MA (US); Michael Super, Lexington, MA (US); Ryan M. Cooper, Cambridge, MA (US); Karel Domansky, Charlestown, MA (US); Chong Wing Yung, Freemont, CA (US)

(21) Appl. No.: 13/918,193

(22) Filed: Jun. 14, 2013

Related U.S. Application Data
(60) Provisional application No. 61/660,033, filed on Jun. 15, 2012.

(51) Int. Cl. B03C 1/28

(52) U.S. Cl. CPC B03C 1/28
USPC 210/222

(57) ABSTRACT

A system and method for removing a target species from a fluid source is provided. The system includes a reciprocating fluid cleansing device, including a processing chamber with a port at a first end for fluid passage and a movable plunger at a second end, wherein the plunger in contact with a fluid includes a motorized mixing element for mixing the fluid with species-targeting magnetic particles. Motion of the plunger in a first direction transfers a first volume of the fluid from the fluid source into the processing chamber. Motion of the plunger in a second direction transfers the first volume of the fluid from the processing chamber to a fluid destination. At least one magnetic element provides a magnetic field gradient within the processing chamber. A connector connects the port of the first processing chamber to the fluid source and the fluid destination.

### CROSS REFERENCE TO RELATED APPLICATIONS

This application claims the benefit under 35 U.S.C. §119(e) of U.S. Provisional Application No. 61/660,033 filed Jun. 15, 2012, the content of which is incorporated herein by reference in its entirety.

### GOVERNMENT SUPPORT

This invention was made with government support under W81XWH-09-2-0001 awarded by U.S. Army. The government has certain rights in the invention.

### TECHNICAL FIELD

The present disclosure relates to systems, devices and methods for cleansing fluids, and more particularly, systems, devices and methods for removing one or more components and/or contaminants of interest from fluids.

### BACKGROUND

In the U.S., sepsis is the second-leading cause of death in non-coronary ICU patients, and the tenth-most-common cause of death overall. Sepsis is a serious medical condition that is characterized by a whole-body inflammatory state (called a systemic inflammatory response syndrome) and the presence of a known or suspected infection. Sepsis typically occurs during bacteremia, viremia or fungemia, and may result from infections that are caused by pathogens, such as Staphylococcus aureus, that are not typical blood-borne pathogens. Blood-borne pathogens are microorganisms that cause disease when transferred from an infected person to another person through blood or other potentially infected body fluids. The most common diseases include Hepatitis B, Human Immunodeficiency Virus, malaria, Hepatitis C, and syphilis.

Unfortunately, systemic inflammatory response syndrome may become life threatening before an infective agent has been identified by blood culture. This immunological response causes widespread activation of acute-phase proteins, affecting the complement system and the coagulation pathways, which then cause damage to both vasculature and organs. Various neuroendocrine counter-regulatory systems are also activated, often compounding the problem. Even with immediate and aggressive treatment, this can progress to multiple organ dysfunction syndrome and eventually death. Hence, there remains a need for improved techniques for diagnosis and treatment of patients with infectious diseases, blood-borne infections, sepsis, or systemic inflammatory response syndrome. Some treatments of sepsis include continuous removal of blood, cleansing of the blood and continuous return of the cleansed blood to a subject. Current blood cleansing systems and methods have significant shortfalls that make them ill-suited for use in blood cleansing of pathogens for sepsis therapy.

Some presently existing devices utilize high-energy ultrasonic waves in syringe-like devices to homogenize non-biological colloids. However, this technology would be highly disruptive to certain biological components and would be especially impractical for applications involving blood, proteins, cells, which would lyse or denature when exposed to ultrasound. Accordingly, there is a need for an improved blood cleansing device and method that can be used to cleanse blood, e.g., for sepsis therapy.

### SUMMARY

One aspect of the present disclosure provides a system for removing at least one target species from a fluid. The system can be used to simultaneously collect or draw a volume of fluid from a fluid source, remove one or more target species from the volume of the fluid, and return a cleansed fluid to a fluid destination. Alternatively, the system can perform these processes in a sequential manner. The system comprises a reciprocating fluid cleansing device and a first connector configured to provide fluid communication between the reciprocating fluid cleansing device and a fluid source and a fluid destination. The reciprocating fluid cleansing device includes a first processing chamber including a port at a first end for fluid passage and a first movable plunger disposed at a second end. The first movable plunger is configured to be in contact with a fluid and includes a motorized mixing element for mixing the fluid with species-targeting magnetic particles. Motion of the first movable plunger in a first direction is configured to transfer a first volume of the fluid from the fluid source into the first processing chamber. Motion of the first movable plunger in a second direction is configured to transfer the first volume of the fluid from the first processing chamber to a fluid destination. At least one magnetic element provides a magnetic field gradient within the first processing chamber, e.g., to allow removal of magnetically-labeled target species from the fluid before it is transferred to the fluid destination. The first connector connects the port of the first processing chamber to fluid source and the fluid destination.

In some embodiments, the reciprocating fluid cleansing device can further comprise a second processing chamber, which includes a port at its first end for fluid passage and a second movable plunger disposed at its second end, wherein the second movable plunger is mechanically coupled to the first movable plunger of the device such that the motion of the first movable plunger in the first direction transfers the first volume of the fluid from the fluid source into the first processing chamber and simultaneously transfers a second volume of a fluid from the second processing chamber to the fluid destination; and the motion of the first movable plunger in the second direction transfers the first volume of the fluid from the first processing chamber to the fluid destination and simultaneously transfers a third volume of the fluid from the fluid source into the second processing chamber. At least one magnetic element provides a magnetic field gradient within the second processing chamber, e.g., to allow removal of magnetically-labeled target species from the fluid before it is transferred to the fluid destination. The continuous reciprocating movement of the first and second movable plungers with their respective processing chambers permits simultaneous withdrawal of a volume of a fluid to be cleansed from a fluid source and delivery of a volume of a cleansed fluid to a fluid destination, thus increasing the efficiency and/or throughput of removing at least one target species from a fluid.

Another aspect of the present disclosure provides a reciprocating fluid cleansing device, which for example, can be used to remove at least one or more target species from a fluid. The reciprocating fluid cleansing device comprises a first processing chamber including a port at a first end for fluid passage and a first movable plunger disposed at a second end. The first movable plunger is configured to be in contact with a fluid and includes a motorized mixing element for mixing the fluid with species-targeting magnetic particles. Motion of the first movable plunger in a first direction is configured to transfer a first volume of the fluid from the fluid source into the first processing chamber. Motion of the first movable plunger in a second direction is configured to transfer the first volume of the fluid from the first processing chamber to a fluid destination. At least one magnetic element provides a magnetic field gradient within the first processing chamber, e.g., to allow removal of magnetically-labeled target species from the fluid before it is transferred to the fluid destination.

According to yet another aspect of the present disclosure, provided herein is a method for removing at least one target species from a fluid. The method comprises providing a system or reciprocating device described herein for performing the following acts. In the absence of a first magnetic field gradient, a first volume of fluid is transferred from a fluid source into a first processing chamber. A motorized mixing element of the first processing chamber is activated to mix the first volume of the fluid loaded in the first processing chamber with a first plurality of species-targeting magnetic particles. The species-targeting magnetic particles can be introduced into the first processing chamber prior to or after introduction of the first volume of the fluid into the first processing chamber. Upon mixing of the first volume of the fluid with the species-targeting magnetic particles, at least a portion of the first plurality of the species targeting magnetic particles bind to the target species present in the first volume of the fluid. The magnetic element of the first processing chamber is activated to generate the first magnetic field gradient sufficient to separate the first plurality of the species-targeting magnetic particles (that are bound to the target species or remain unbound) from the first volume of the fluid to yield a first magnetic particle-free fluid. While the species-target magnetic particles (that are bound to the target species or remain unbound) are immobilized within the first processing chamber in the presence of the first magnetic field gradient, the first magnetic particle-free fluid is transferred to the fluid destination, thereby removing the target species from the first volume of the fluid.

The systems, devices and methods described herein can be used to cleanse or dialyze any fluid, including, but not limited to, biological fluids (e.g., blood, cerebrospinal fluid, milk, or urine), aqueous fluids (e.g., water, or wastewater), or organic fluids (e.g., oil, or organic solvents). The systems, devices and methods described herein can be used in any applications where magnetic molecules or magnetically-labeled molecules are desired to be separated from a fluid. In some embodiments, the systems, devices and methods described herein can be used to treat bloodstream infections in patients, e.g., induced by sepsis and/or injury. For example, infected blood from a patient can be flown into the system and/or device described herein and mixed with magnetic particles coated with engineered microbe-targeting molecules as described in U.S. Pat. App. Pub. No. US 2013/0035283 and International Pat. App. Pub. No. WO 2013/012924 (e.g., but not limited to FcMBL-coated magnetic particles) to cleanse the blood of pathogens. The microbe-targeting magnetic particles capture pathogens present in the infected blood and are then isolated from the blood by magnetic separation so that the cleansed blood can flow back to the patient.

Additional aspects of the invention will be apparent to those of ordinary skill in the art in view of the detailed description of various embodiments, a brief description of which is provided below.

### BRIEF DESCRIPTION OF THE DRAWINGS

The following summary, as well as the following detailed description of the present disclosure, will be better understood when read in conjunction with the appended drawings. For the purpose of illustrating the present disclosure, there are shown in the drawings embodiments which are presently preferred. It should be understood, however, that the present disclosure is not limited to the precise arrangements and instrumentalities shown.

FIG. 1A is a diagrammatic view of an embodiment of a system comprising a reciprocating fluid cleansing device.

FIG. 1B is a diagrammatic view of another embodiment of a reciprocating fluid cleansing device with a different movable plunger.

FIG. 2 is a diagrammatic view of an embodiment of a reciprocating fluid cleansing device and/or system, wherein two movable plungers 102, 202 are mechanically coupled to one another such that the motion of the first movable plunger 102 to withdraw a fluid from the fluid source 116 can simultaneously cause the second movable plunger 202 to dispense a fluid to the fluid destination 118 (the fluid flow is represented by dashed arrows); and the motion of the first movable plunger 102 to dispense the fluid to the fluid destination 118 can simultaneously cause the second movable plunger 202 to withdraw a new fluid from the fluid source 116 (the fluid flow is represented by dotted arrows).

FIGS. 3A-3B are diagrammatic views of other exemplary configurations of at least two movable plungers mechanically coupled to one another.

FIG. 4 is a diagrammatic view of one embodiment of a reciprocating fluid cleansing device and/or system, which further comprises a supply chamber containing species-targeting magnetic particles.

FIG. 5 is a diagrammatic view of one embodiment of a reciprocating fluid cleansing device and/or system, which further comprises a detection module and a supply chamber providing species-targeting magnetic particles.

FIG. 6 is a diagrammatic view illustrating various embodiments of the mixing element.

FIG. 7 is an image illustrating some exemplary embodiments of a movable plunger (for 20 mL syringe barrels) mounted with a motorized mixing element on one end.

FIG. 8 shows different diagrammatic perspectives of one embodiment of a movable plunger containing battery power, switch, and potentiometer for variable speed control.

### DETAILED DESCRIPTION OF THE INVENTION

Although the invention will be described in connection with certain preferred embodiments, it will be understood that the invention is not limited to those particular embodiments and the particular methodology, protocols and reagents described therein as such may vary. On the contrary, the invention is intended to cover all alternatives, modifications, and equivalent arrangements as may be included within the spirit and scope of the invention as defined by the appended claims. The terminology used herein is for the purpose of describing particular embodiments only, and is not intended to limit the scope of the present invention, which is defined solely by the claims.

As used herein and in the claims, the singular forms include the plural reference and vice versa unless the context clearly indicates otherwise. Other than in the operating examples, or where otherwise indicated, all numbers expressing quantities of ingredients or reaction conditions used herein should be understood as modified in all instances by the term “about.”

All patents and other publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Unless defined otherwise, all technical and scientific terms used herein have the same meaning as those commonly understood to one of ordinary skill in the art to which this invention pertains, unless expressly defined otherwise. Although any known methods, devices, and materials may be used in the practice or testing of the invention, the methods, devices, and materials in this regard are described herein.

The present disclosure provides, inter alia, a system, device and method for continuously or intermittently cleansing or dialysis of any fluid, including, but not limited to, biological fluids (e.g., blood, CSF, milk, or urine), aqueous fluids (e.g., water, or wastewater), or organic fluids (e.g., oil, or organic solvents). For example, provided herein are systems, devices and methods for removing at least one target species (including, but not limited to, cells, microbes, toxins, proteins, molecules, or particulates) from any fluid. In some embodiments, it can be desirable to have a mixing and/or cleansing system, device and method that can be used and/or fitted with existing delivery devices or chambers of various sizes (e.g., laboratory or medical syringes) to enable cleansing or continuous cleansing (including mixing and dispensing) of a wide variety of liquids, gases, suspensions, colloids, solids or any combination thereof that would otherwise quickly settle out, precipitate or phase separate. In some embodiments, it can be desirable to reduce the amount of dead space in the mixing and/or cleansing system (e.g., smaller than about 2 to about 2.5 ml, or less than about 10% of a fluid to be cleansed). Using the systems and methods described above, high isolation efficiencies can be reached.

### Reciprocating Fluid Cleansing Devices and Systems Comprising the Same

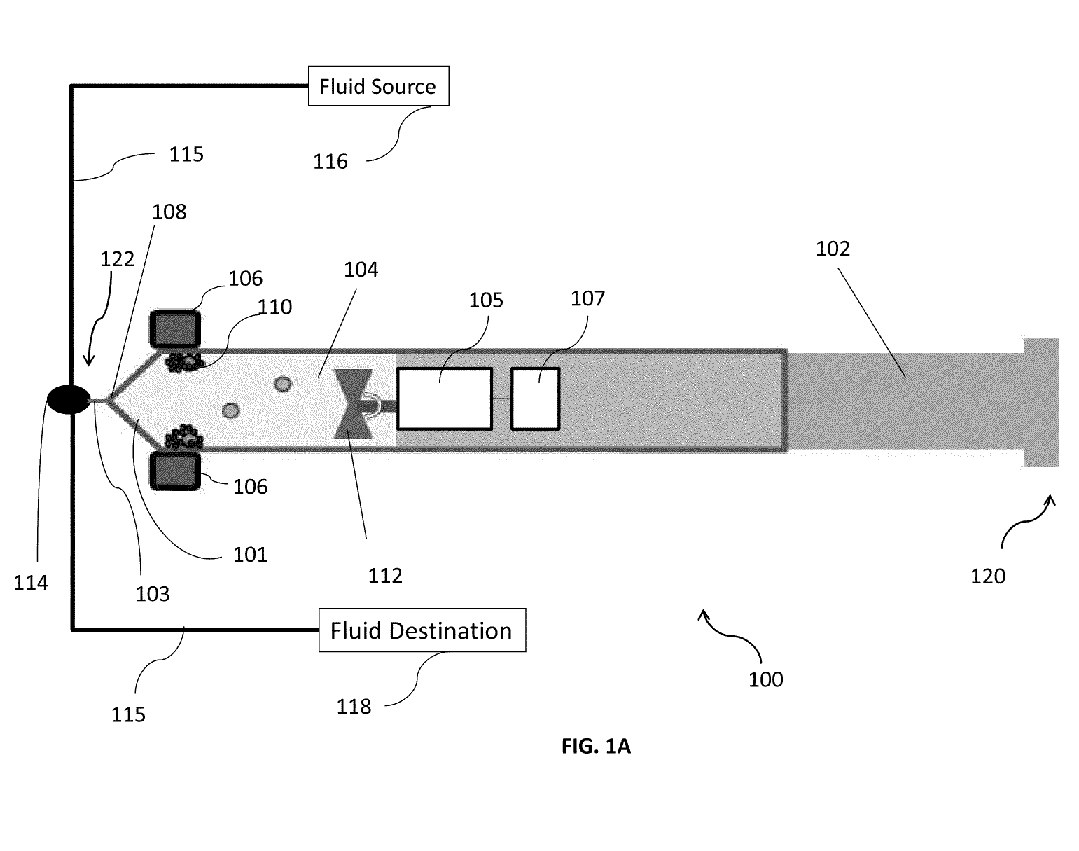

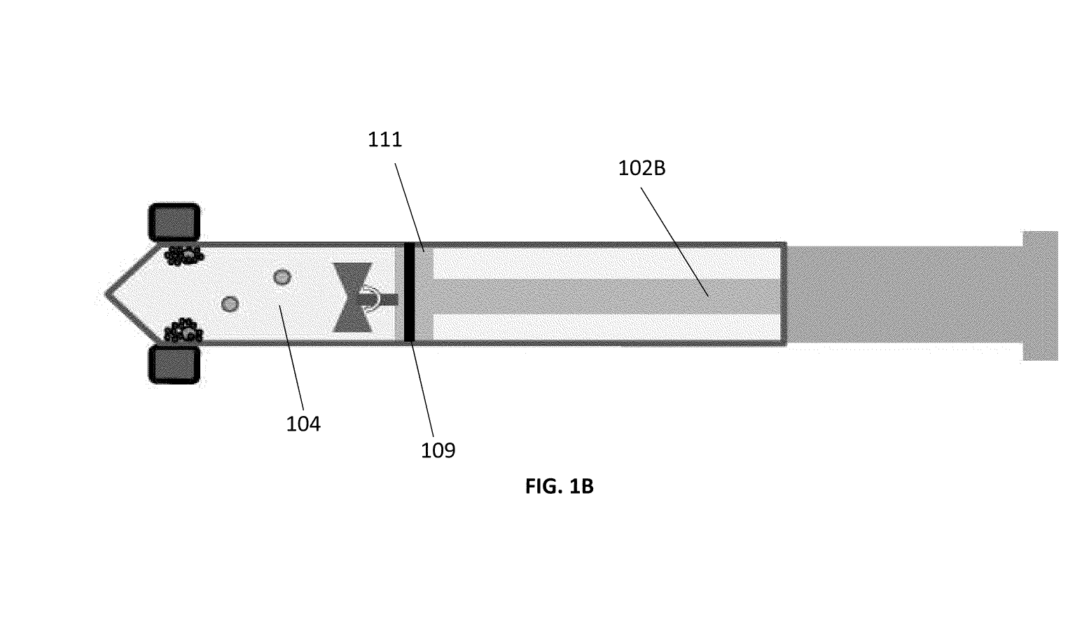

Referring now to FIG. 1A, provided herein is a system comprising a reciprocating fluid cleansing device 100 containing a first processing chamber 104 and at least one magnetic element 106. As shown in FIG. 1A, the reciprocating fluid cleansing device 100 has a first end 122 and a second end 120 that can be generally opposite to the first end 122. The reciprocating fluid cleansing device 100 further includes a port 108 proximate the first end 122 for fluid passage. The reciprocating fluid cleansing device 100 is also equipped with a first movable plunger 102 proximate the second end 120. The system can further comprise a first connector 114 connecting the port 108 of the first processing chamber 104 to a fluid source 116 and a fluid destination 118, for example, as shown in FIG. 1A.

While FIGS. 1A and 1B illustrate that the first processing chamber 104 is housed or constructed within a fluid delivery device, e.g., a syringe, one of skill in the art can appreciate that the first processing chamber 104 can be adapted or constructed as part of a fluid-flowing channel or conduit of a process, e.g., in manufacturing or processing plants or instruments.

The first processing chamber 104 can be present in any form and have a cross-section of any shape, e.g., a circle, an ellipse, a triangle, a square, a rectangle, a polygon or any irregular shape. In some embodiments, the shape and/or dimensions of the first processing chamber 104 can be designed, for example, to provide sufficient fluid capacity and/or optimum mixing, and to permit reciprocating movement of the plunger therein to withdraw or dispense a volume of a fluid. In some embodiments, the first processing chamber 104 can be present in a form of a cylindrical barrel or tube.

The first processing chamber 104 can be made of any material, e.g., any material that is compatible and/or inert to a fluid to be processed. In some embodiments, the first processing chamber 104 can be made of any biocompatible material known in the art, e.g., but not limited to, TEFLON®, polysulfone, polypropylene, polystyrene, or any material commonly used to construct medical or laboratory syringes. In other embodiments, the plunger can be made of a material that is resistant and/or inert to an organic solvent, if present, in the fluid to be processed. In accordance with the systems, devices and/or methods described herein, the materials used for construction of the first processing chamber should be susceptible to a magnetic field, so that a magnetic field gradient can be created within the first processing chamber 104, e.g., to immobilize magnetically-labeled particles therein.

In some embodiments, it can be desirable to select a material for construction of the first processing chamber with low binding capability and/or to adapt the fluid-contact surface of the first processing chamber to become less adhesive in order to reduce or minimize adhesion or adsorption of one or more components present in the fluid onto the chamber surface. Methods for modification of a material surface to reduce or minimize non-specific binding are known in the art, e.g., coating a surface with a hydrophobic material that prevents molecules from adhering or adsorbing to the surface. In one embodiment, the fluid-contact surface of the first processing chamber can be coated using Slippery Liquid-Infused Porous Surface (SLIPS) technology as described in Wong et al. “Bioinspired self-repairing slippery surfaces with pressure-stable omniphobicity” Nature (2011) 477: 443-447. In some embodiments, by coating the fluid-contact surface of the first processing chamber 104 with SLIPS, blood cleansing using the system and/or reciprocating fluid cleansing device described herein can be carried out without the need for anticoagulants to prevent blood clotting.

The size and/or volume of the first processing chamber 104 can vary depending on a number of factors, including, but not limited to, volume of a fluid to be processed, and/or types of applications. In general, a larger first processing chamber 104 is used to process a larger volume of a fluid. In some embodiments, the first processing chamber can have a fluid capacity of about 0.1 mL to about 500 mL, about 0.5 mL to about 250 mL, about 1 mL to about 100 mL, about 2 mL to about 80 mL, or about 3 mL to about 60 mL. In other embodiments, the first processing chamber can have a fluid capacity of larger than 500 mL, larger than 600 mL, larger than 700 mL, larger than 800 mL, larger than 900 mL, larger than 1000 mL or higher. In some embodiments, the processing chamber is not a microfluidic processing chamber.

The port 108 of the first processing chamber 104 can have an opening or an aperture of any size that allows a fluid to flow through, e.g., from a fluid source to the first processing chamber or from the first processing chamber to a fluid destination. In some embodiments, e.g., a syringe-like reciprocating device as shown in FIG. 1A, the port 108 at the first end 122 of the first processing chamber 104 can have a cross-section smaller than that of the first processing chamber 104, for example, a port with a cross-sectional area at least about 10%, at least about 20%, at least about 30%, at least about 40%, at least about 50%, at least about 60%, at least about 70%, at least about 80%, at least about 90%, at least about 95% smaller than that of the first processing chamber. In other embodiments, the port 108 can have a cross-section substantially same as that of first processing chamber 104.

As used herein, the term “movable plunger” refers to any structural component that can be displaceably inserted into a processing chamber of the reciprocating device described herein, and can transfer a volume of fluid into or out of the processing chamber as a result of its displacement. The plunger can take any form, for example, but not limited to, a cylindrical construction 102 (FIG. 1A), a barrel-shaped construction, or a piston with a connected rod 102B (FIG. 1B). Generally, a movable plunger described herein is constructed to provide a sufficiently tight edge closure between at least part of an exterior lateral surface of the plunger 102 and at least part of an interior lateral wall of the first processing chamber 104, e.g., at least along a length where the plunger is displaceable. In some embodiments, the portion of the plunger to be moved inside along the first processing chamber can have a uniform cross-section such that a sufficiently tight edge closure is provided, e.g., as shown in FIG. 1A. In alternative embodiments, at least a proximate end 111 of the plunger 102B extending into the first processing chamber 104 can have a cross-section large enough to provide a sufficiently tight disclosure, e.g., as shown in FIG. 1B.

As used herein, the phrase “sufficiently tight edge closure” refers to a gap formed between the exterior lateral surface of the plunger 102 and the interior lateral wall of the first processing chamber 104 that permits displacement of the plunger within the processing chamber but prevents any fluid from permeating therethrough. In some embodiments, the phrase “sufficiently tight edge closure” refers to a gap formed between the exterior lateral surface of the plunger 102 and the interior lateral wall of the first processing chamber 104 that is no larger than 3 mm, no larger than 2 mm, no larger than 1 mm, no larger than 0.5 mm, no larger than 0.1 mm or smaller. In one embodiment, the gap formed between the exterior lateral surface of the plunger and the interior lateral wall of the first processing chamber can be undetectable by any art-recognized methods, or substantially equal to zero, e.g., at least part of both surfaces are contacting one another. In some embodiments, at least a portion of the movable plunger (e.g., the proximate end extending into the first processing chamber 104) can be fitted with a gasket 109 (e.g., an O-ring such as a silicon O-ring) to create a seal at the interface between the exterior lateral surface of the plunger and the interior lateral wall of the first processing chamber. This can prevent leakage of a fluid between the first processing chamber and the plunger body.

The plunger can be made of any material, e.g., any material that is compatible and/or inert to a fluid to be processed. In some embodiments, the plunger can be made of any biocompatible material known in the art, e.g., but not limited to, TEFLON®, polysulfone, polypropylene, polystyrene, or any material commonly used to construct medical or laboratory syringes. In other embodiments, the plunger can be made of a material that is resistant and/or inert to an organic solvent, if present, in the fluid to be processed. In some embodiments, the plunger can be made of a material that is suitable for construction of the processing chamber described herein. In some embodiments, the fluid-contact surface of the plunger can be modified, e.g., by coating the surface with a less-adhesive material, to reduce or minimize adhesion or adsorption of one or more components present in the fluid thereon.

The first movable plunger of the reciprocating fluid cleansing device described herein includes one or more mixing elements. For example, as shown in FIG. 1A, the first movable plunger 102 has one end extending into the first processing chamber 104 of the reciprocating device 100 and can further include a mixing element 112 coupled to or adjacent to the plunger 102. The mixing element 112 can be motorized and further extend into the first processing chamber 104.

The mixing element 112 can be machined from any material, e.g., any material that is compatible to a fluid to be processed. In some embodiments, the mixing element can be made of any biocompatible material known in the art, e.g., but not limited to, TEFLON®, polysulfone, polypropylene, polystyrene, or any combinations thereof. In some embodiments, the mixing element can be made of a material that is resistant and/or inert to an organic solvent, if present, in the fluid to be processed. In some embodiments, the mixing element 112 can be made of a material that is suitable for construction of the processing chamber or plunger described herein. In some embodiments, the fluid-contact surface of the mixing element can be modified, e.g., by coating the surface with a less-adhesive material, to reduce or minimize adhesion or adsorption of one or more components present in the fluid thereon. In some embodiments where the mixing element is desired to be electromagnetic, the mixing element can be made of or comprise electromagnetic materials, e.g., but not limited to iron oxides. In some embodiments, the mixing element can be machined or made from polysulfone.

As used herein, the term “mixing element” refers to any structural component constructed to facilitate mixing a fluid (e.g., with a component such as species-targeting magnetic particles), homogenizing a component in a fluid, and/or dispersing particulates in a fluid. Accordingly, the mixing element can be configured to have any shape, depending on applications such as low-shear mixing (e.g., to prevent cell lysis or hemolysis) or high-shearing mixing (e.g., to facilitate lysis or homogenizing a component in a fluid). The size of the mixing element can vary with a number of factors, including but not limited to, the cross-sectional dimension of the movable plunger, size of the first processing chamber, viscosity of the fluid, number of mixing elements, and/or desirable fluid dynamics. In some embodiments, a plurality of smaller mixing elements (e.g., 2, 3, 4, 5, 6, 7, 8, 9, 10 or more mixing elements) can be used instead of a large single mixing element to provide a more controlled mixing. In some embodiments, the mixing element can include an impeller. The term “impeller” as used herein refers to any structures that can be caused to move and in turn cause molecules locating proximate the impeller to move in response to the motion of the impeller. In some embodiments, the impeller can include rotary impeller.

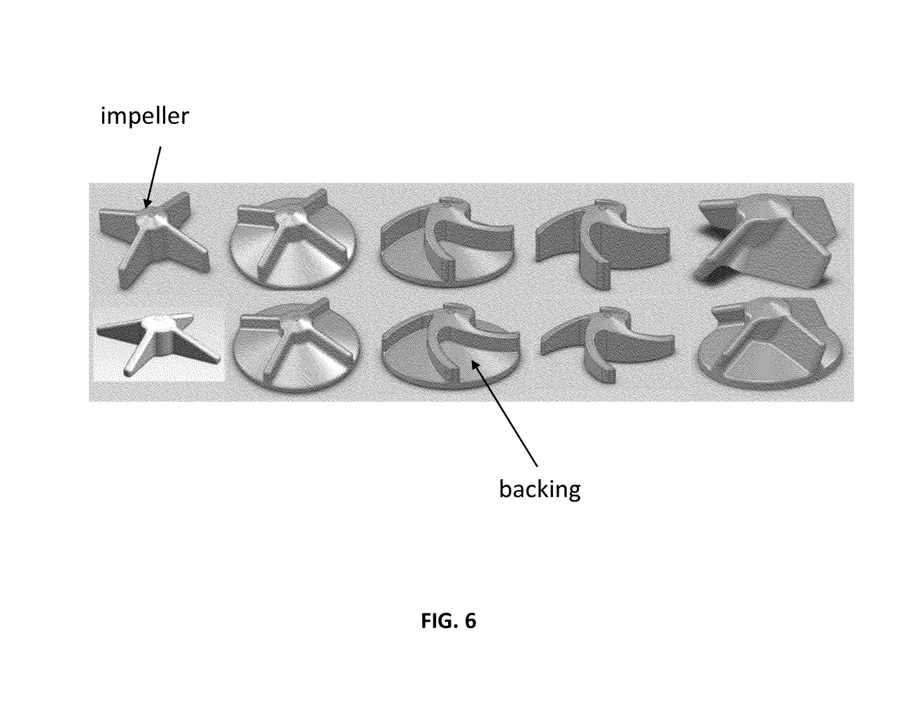

The mixing element 112 can be used to mix a wide variety and combination of fluids, solids and gases. The mixing element 112 can be configured or designed to provide mixing for low-shear applications or high-shear turbulent mixing efficiency applications. As used herein, the term “low-shear mixing” generally means a laminar-flow type of mixing. In some embodiments, the term “low-shear mixing” with respect to a physiological range (e.g., in a human being) refers to a mixing with a shear stress of less than 1 dyne/cm². As used herein, the term “high-shear mixing” generally means a turbulent-flow type of mixing. In some embodiments, the term “high-shear mixing” with respect to a physiological condition (e.g., in a human being) refers to a mixing with a shear stress of higher than 1 dyne/cm² and less than 15 dynes/cm². By way of example only, the low-shear mixing can be used to gently mix and pump a fluid (e.g., whole blood) with magnetic particles 110 (e.g., superparamagnetic beads) that are designed to bind to a target species present in the fluid, e.g., microbial contaminants such as fungi, bacteria and others within the blood, without causing damage to or significantly diluting the fluid. An exemplary type of microbe-binding magnetic particles includes MBL-coated magnetic beads, or FcMBL-coated magnetic beads described in U.S. Pat. App. Pub. No. US 2013/0035283 and International Pat. App. Pub. No. WO 2013/012924, the contents of which are incorporated herein by reference. If the fluid is blood, low-shear impeller configurations and/or power inputs can be used to prevent hemolysis and shear-activated coagulation of whole blood. FIG. 6 illustrates different exemplary embodiments of the mixing element 112 that is an impeller designed for low-shear mixing applications. Corners and/or edges of the impellers can be rounded to reduce shear surfaces on the impellers. In some embodiments, all corners and edges can be rounded to minimize shear surfaces on the impellers. In some embodiments, impellers can be designed to minimize the flow of fluids behind impeller blades and/or local turbulence, for example, by designing impellers with backings as shown in FIG. 6. Optimum design of impellers for various low-shear and/or high-shear applications can be facilitated, e.g., by empirical testing and/or computational modeling. High-shear mixing applications can include the use of the mixing element 112 to fluidize dense particles or particulates in a fluid (e.g., immunomagnetic beads such as magnetic beads 110 coated with an antibody present in saline solution) to form a homogeneous suspension of particles or particulates within the first possessing chamber 104.

In some embodiments, for example, where cell lysis (e.g., blood lysis) is desirable, the mixing element 112 can be a flexible elongated structure (e.g., in a form of a strip or rod) or include soft ribbons of a fluid-compatible material protruding from a septum (e.g., a rubber septum) attached to one end of the movable plunger that brings into contact with a fluid. The septum can be nutated with a motor. For example, the septum with the flexible elongated structures (e.g., in a form of a strip or rod) or ribbons can be nutated by a motorized setup, e.g., an acentric motorized setup such as a cam assembly behind the septum. The soft and/or flexible elongated structures (e.g., strips or rods) or ribbons can extend and collapse freely to mix along the whole length of the processing chamber (e.g., but not limited to a syringe barrel) even as the plunger 102 is moving. In some embodiments, a septum in such a configuration can serve as both the mixer and a non-rotating seal that is fully disposable.

In some embodiments, the mixing element need not include an impeller, but at least two electromagnets placed opposite on either side of the mixing region of the processing chamber 104 to form a cycling electromagnetic mixer.

In certain exemplary aspects of the present disclosure, the mixing element 112 can be built into a plunger 102 of a reciprocating fluid delivery device (e.g., a syringe-like reciprocating fluid delivery device as shown in FIG. 1A). The mixing element can be built integral to the plunger or can be detachable from the plunger.

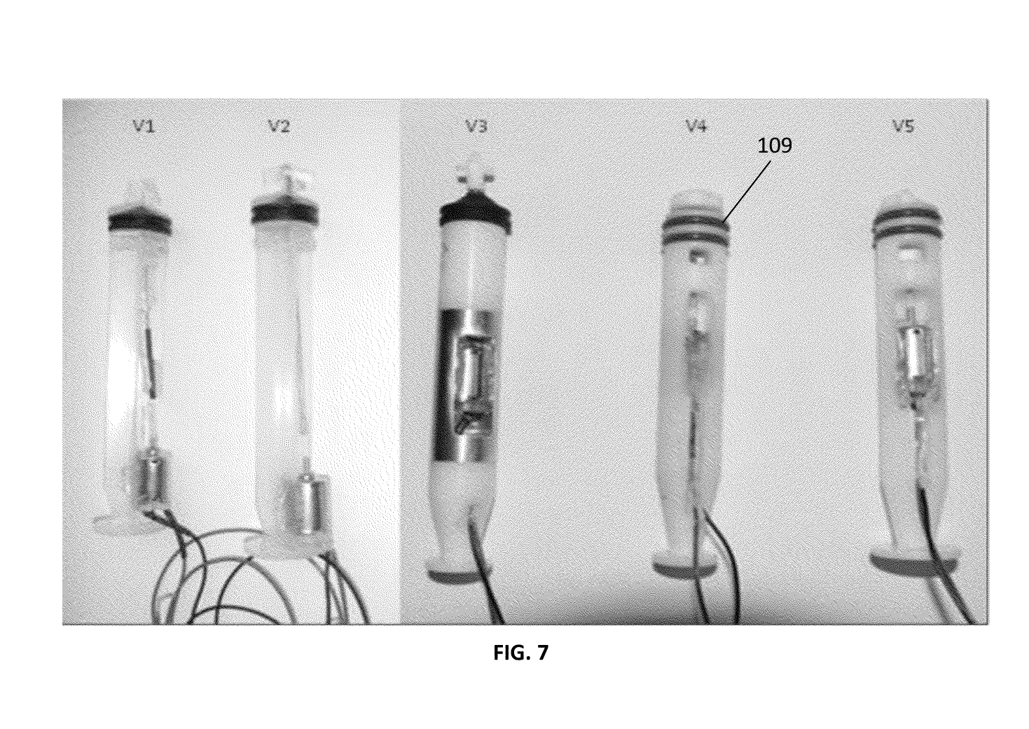

In some embodiments, the mixing element 112 can be motorized, e.g., the mixing element is connected to or equipped with a motor. In some embodiments, the speed of the mixing achieved with the mixing element 112 (e.g., a motorized mixing element) can be adjustable or can be varied according to different circumstances. For example, as shown in FIG. 7, the mixing element can be mounted to the plunger 102 and connected to a motor 105 by an impeller shaft as would be understood in the field of the present disclosure. In certain exemplary aspects the motor 105 can be battery-operated (e.g., battery 107) and mounted at any point within the length and the diameter of the plunger 102 such that it will minimize or limit any interference with the movement of the plunger 102 as it is depressed or pulled. In addition to being motorized, the mixing element 112 may also be operated by hand. While the mixing element 112 can be motorized, in some embodiments, the mixing element 112 can also be constructed to be operated by hand.

In certain exemplary aspects of the present disclosure, the first movable plunger 102 can include any additional electrical, mechanical and/or sensing device or unit, including, but not limited to, a tachometer wheel, a switch, a potentiometer speed dial, a battery 107 or any combination thereof. By way of example only, the battery 107 can be located anywhere along the length of the plunger 102. For example, the tachometer wheel can be mounted on an impeller shaft, between the impeller and the motor 105 (e.g., of a motorized mixing element) to enable wireless rpm-measurements using an external laser tachometer.

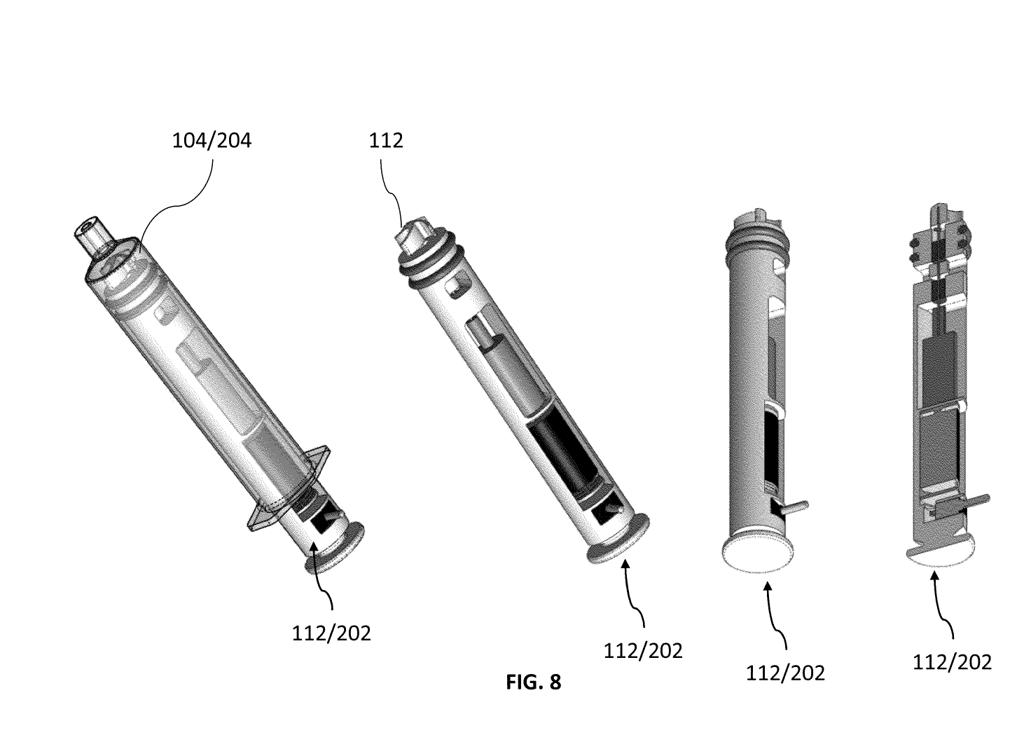

In one embodiment, for example, as shown in FIG. 8, the movable plunger 102 or 202, optionally containing one or more electrical, mechanical and/or sensing components described herein, can be constructed to retrofit a variety of any common laboratory or medical syringes, such as syringes with capacities of about 1 mL to about 60 mL and larger, e.g., to enable continuous mixing and dispensing of any combination of liquids, gases or solids that would otherwise quickly settle out, precipitate or phase separate. The mixing element 112 can fit within a variety of common syringes, which can be mounted on standard syringe pumps to take advantage of their precise dispensing capabilities.

Accordingly, another aspect described herein provides a movable plunger adapted to fit for use with a syringe. The movable plunger 102 or 202 comprises an embodiment of the mixing element 112 described herein. In some embodiments, the mixing element 112 can be solely a mechanical mixing element. In some embodiments where the mixing element 112 comprises a magnetizable or electromagnetic material, at some times, the mixing element 112 can act as a mechanical mixing element alone when a magnetic field gradient is not required, for example, during mixing of the fluid with the magnetic particles; at some other times, the mixing element 112 can act as a magnetic element alone when mixing is not required, for example, during isolation of the magnetic particles from the fluid; and at some other times, the mixing element 112 can act as a magnetic mixing element, which can mix the fluid to facilitate separation of the magnetic particles from the fluid and/or collection of the isolated magnetic particles onto the surface of the mixing element. As described above, in some embodiments, the body of the movable plunger can further comprise an energy source (e.g., a battery) for operating a motor electrically connected to the mixing element. In some embodiments, the body of the movable plunger can further comprise one or more electrical, mechanical and/or sensing devices or units, including, but not limited to, a tachometer wheel, a switch, a potentiometer speed dial, and any combination thereof.

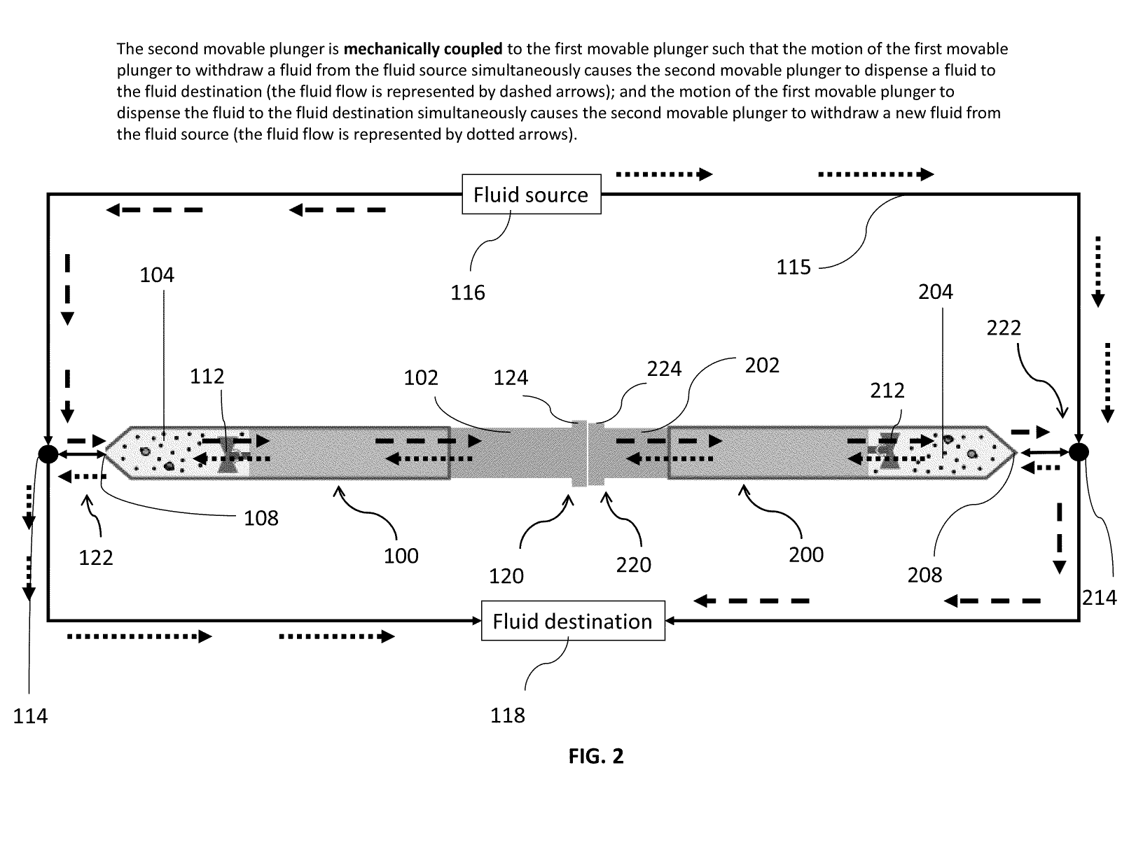

Reciprocating motion of the fluid cleansing device described herein can be either linear, i.e., back and forth along a straight-line axis (e.g., as shown in FIG. 2); or angular, i.e., back and forth along a curved, arched or angled axis. During reciprocating motion, movement of the first movable plunger 102 in a first direction towards the second end 120 of the reciprocating fluid cleansing device 100 can cause a predetermined amount of fluid to be transferred from the fluid source 116 through the port 108 into the first processing chamber 104. The movement of the first plunger 102 in a second direction towards the first end 122 can cause the predetermined volume of fluid to be transferred from the port 108 of the first processing chamber 104 to the fluid destination 118. The magnitude and rate of the displacement of the movable plunger 102 within the processing chamber 104 can control the volume and rate of the fluid being transferred into or out of the processing chamber 104, respectively.

In embodiments described herein, the reciprocating fluid cleansing device comprises at least one magnetic element configured to provide a magnetic field gradient within the first processing chamber. For example, as shown in FIG. 1A, the syringe-like reciprocating fluid cleansing device 100 can include at least one magnetic element 106 configured to provide a magnetic field gradient within the first processing chamber 104. In certain exemplary aspects, the first processing chamber 104 can include at least one magnetic element 106 removably attached to the outside of the first processing chamber 104. The magnetic element 106 can be removably attached to the outside of the first processing chamber 104 proximate the first end 122, or along a certain length of the first processing chamber 104. In such embodiments, depending on the strength of the magnetic field or the magnetic field gradient, the magnetic element 106 can be placed in contact around the exterior surface of the first processing chamber 104, for example as shown in FIG. 1A; or placed a certain distance away from the outside wall of the first processing chamber 104 when the magnetic field or the magnetic field gradient is strong enough. One of skill in the art can determine optimum placement of such magnetic element depending on types of the magnetic element. The magnetic element 106 can be a permanent magnet or an electromagnet.

For example, a stationary magnet can be placed around the processing chamber 104 (e.g., syringe) to create a magnetic field gradient sufficient to immobilize the magnetic particles or species-targeting magnetic particles 110, e.g., on the side wall of the processing chamber, and thus prevent the magnetic beads 110 from being pushed out of the first processing chamber 104 along with the fluid (e.g., blood) as the fluid is transferred out to the fluid destination 118. The stationary magnet, such as the magnetic element 106 shown in FIG. 1A, can then be removed during fluid transfer (e.g., blood transfer) from the fluid source 116 to the first processing chamber 104. The magnetic particles or species-targeting magnetic particles 110 can then be mixed with the fluid (e.g., blood) with the mixing element 112, e.g., in the absence of the stationary magnet, and the stationary magnet can then be reapplied again. The process can be repeated several times, as necessary. In some embodiments, the process can be repeated without replacing the magnetic particles or species-targeting magnetic particles 110 as long as the binding capacity of the species-targeting magnetic particles 110 is not saturated. In some embodiments where an electromagnet is used in place of a stationary magnet, the magnetic field gradient can be turned on or off by control of a flow of electric current through the magnet (without the need to physically place and remove the magnet as needed in the case of the stationary magnet).

In certain exemplary aspects, the reciprocating fluid cleansing device 100 can include one or more magnetic elements 106 placed at different locations along the outer surface of the first processing chamber 104. By way of example only, as shown in FIG. 1A, the magnetic element(s) 106 can be placed proximate a neck portion 103 prior to transferring the blood to the fluid destination 118. The magnetic element 106 can also be placed proximate the exterior surface of an angled portion 101 of the reciprocating fluid cleansing device 100. Additionally or alternatively, the magnetic element(s) 106 can be placed upstream along the length of the first processing chamber 104, e.g., the magnetic element(s) 106 can be placed proximate the exterior surface toward the end of the plunger extending into the first processing chamber 104. In such embodiments, the magnetic beads or particles can be distributed more sparsely and kept further away from the outflow path when a fluid (e.g., blood) is being pushed out.

In certain exemplary aspects, a reciprocating fluid cleansing device 100 can additionally or alternatively include a magnetizable material or scaffold such as steel wool-like mesh, within the first processing chamber 104, e.g., to collect the magnetic particles 110 after the magnetic particles have been mixed in a fluid, for a sufficient period of time, with the mixing element 112.

The magnetic element used in the systems, devices and/or methods described herein can be any magnetic field gradient source, e.g., a permanent magnet, an electromagnet, a magnetizable material, or any combinations thereof. An exemplary permanent magnet for use as a magnetic field gradient source can include, but not limited to, a neodymium magnet, which is a member of the rare earth magnet family and is generally referred to as an NdFeB magnet composed mainly of neodymium (Nd), iron (Fe) and boron (B). Additional examples of permanent magnet materials that can be used as a magnetic field gradient source for the systems, devices and methods described herein can include iron, nickel, cobalt, alloys of rare earth metals, naturally occurring minerals such as lodestone, and any combinations thereof. In some embodiments, the magnetic field gradient source 114 can be a magnetic field concentrator, e.g., as described in U.S. Pat. Appl. No. US 2009/0220932. In such embodiments, a ferromagnetic microstructure such as nickel and permalloy, can be adapted and configured along at least a portion of the length of processing chamber 104 to function as a magnetic field gradient concentrator and thus enhance the magnetic field gradients locally. While FIG. 1A illustrates the magnetic element 106 to be placed outside of the processing chamber 104, the magnetic element 106 can also be integrated as part of reciprocating fluid cleansing device. For example, magnetic or magnetizable materials can be embedded within the wall of the first processing chambers. In these embodiments, the magnetic field gradient generated by the magnetic elements can be adjustable and also be turned on and off (e.g., by control of a flow of an electric current) whenever necessary.

By “magnetic materials” or “magnetizable material” as used herein is meant magnetically susceptible materials, e.g., ferromagnetic, ferrimagnetic, paramagnetic or superparamagnetic materials, that are capable of producing magnetic field gradient when magnetized by an external magnetic field. For instance, the magnetic materials embedded in the wall of processing chamber can be magnetized by an electromagnet and later demagnetized by reversing the polarity of the electromagnetic field. An “electromagnet” is generally a type of magnet in which the magnetic field is produced by the flow of electric current. The magnetic field disappears when the current is turned off. The polarity of the electromagnet can be determined by controlling the direction of the electrical current in the wire. Methods for incorporating magnetic materials to produce a magnetic field gradient within a device has been described in U.S.2004/0018611, the content of which is incorporated herein by reference.

In other exemplary aspects of the present disclosure, at least two magnetic elements 106, e.g., at least two electromagnets, can be placed opposing on either side of the processing chamber (e.g., on either side outside of the processing chamber 104). In such embodiments, by way of example only, magnetic beads can be placed in the processing chamber 104 before use and held in place on one surface of the processing chamber by one activated magnet. Once a fluid (e.g., blood) is pulled into the processing chamber, mixing can occur by cyclically reversing magnet activation so that the magnetic beads can be continuously pulled from one side of the magnet to the other. This can be used with a reciprocating pump in which the processing chambers (e.g., syringes) never fill but simply generate a vacuum to fill and empty these magnetic mixing chambers that are in-line between a fluid source (e.g., an animal) and the processing chambers (e.g., syringes). Accordingly, in some embodiments, the reciprocating cleansing device described herein does not necessarily need a mixing element disposed in the first or second processing chamber.

Thus, in some embodiments, the reciprocating cleansing devices and/or systems described herein can perform mixing of species-targeting magnetic particles with a fluid or liquid, capture of the species-targeting magnetic particles, and flow generation all at once. In other embodiments, a mixer device for mixing the species-targeting magnetic particles with a fluid or liquid can be used as a front end before the fluid from the fluid source enters the processing chamber of the reciprocating cleansing device. Accordingly, another aspect described herein provides a system for removing a target species from a fluid source comprising: (a) a reciprocating fluid cleansing device, comprising: a first processing chamber including a port at a first end for fluid passage and a first movable plunger disposed at a second end, wherein the first movable plunger is configured to be in contact with a fluid; and wherein motion of the first movable plunger in a first direction is configured to transfer a first volume of the fluid from the fluid source into the first processing chamber; and motion of the first movable plunger in a second direction is configured to transfer the first volume of the fluid from the first processing chamber to a fluid destination; (b) a mixer device for mixing the fluid with species-targeting magnetic particles and/or species-targeting molecules, the mixer device being configured to connect between the fluid source and the first processing chamber; and (c) a first connector configured to connect the port of the first processing chamber to the fluid source and the fluid destination. In some embodiments of this aspect, the reciprocating fluid cleansing device can be used to generate the flow/pull of species-targeting magnetic particles and the fluid through the mixer device to facilitate binding of the target species and to capture the species-targeting magnetic particles and bound target species, while mixing of the species-targeting magnetic particles with the fluid can be performed by the mixer device. The mixer device can be placed downstream of the fluid source and upstream of first processing chamber.

In some embodiments, the mixer device can include a spiral mixer. Examples of spiral mixers described in the U.S. Provisional Application No. 61/673,071 filed Jul. 18, 2012 can be used herein. In some embodiments, the mixer device can include on its surface the species-targeting molecules described herein

In some embodiments, the first movable plunger in contact with the fluid further can further include a motorized mixing element described herein for mixing the fluid with the species-targeting magnetic particles.

In certain exemplary aspects of the present disclosure, at least one magnetic element 106 can be disposed in the first processing chamber 104 and/or the second processing chamber 204. For example, in one embodiment, at least one magnetic element 106 can be disposed inside a syringe barrel. In some embodiments, the magnetic element 106 can be disposed in the first processing chamber 104 and/or the second processing chamber 204 by being incorporated into or integrated with the mixing element 112 and/or 212, such that the mixing element 112 and/or 212 can provide the magnetic field gradient within their respective processing chamber 104 or 204. Alternatively, the mixing element 112 and/or 212 can include a magnetizable blade or magnetizable mixing means. The magnetizable blade or magnetizable mixing means can include at least one electromagnet or magnetizable (e.g., but not limited to, superparamagnetic) material that can be intermittently magnetized and/or demagnetized to carry out collection and/or release of the magnetic particles or species-targeting magnetic particles, respectively. In this embodiment, the magnetic element incorporated into the mixing element 112 can be activated prior to transferring (pushing out) the fluid (e.g., blood) to the fluid destination 118, which can in turn cause the magnetic particles 110 to removably attach to the surface of the magnetized mixing element 112. The magnetic element 112 can be deactivated during the filling of the first processing chamber 104 with fluid from the fluid source 116. Thus, at certain times, the mixing element 112 and/or 212 can act as a mechanical mixing element alone when the magnetic field is not required, e.g., when mixing the fluid with the magnetic beads inside the processing chamber. At some other times, the mixing element 112 and/or 212 can act as a magnetic element alone when mixing is not required, for example, during isolation of the magnetic beads from the fluid. At some other times, the mixing element 112 and/or 212 can act as a magnetic mixing element, which can mix the fluid to facilitate separation of the magnetic beads from the fluid and/or collection of the isolated magnetic beads onto the surface of the mixing element. The strength of the magnetic field gradient created by the magnetic mixing element 112 and/or 212 can be adjustable or varied, e.g., by varying the magnitude and/or polarity of the electromagnet integrated into the mixing element.

In other embodiments, the magnetic element 106 disposed in the first processing chamber 104 and/or the second processing chamber 204 can be adapted to be capable of moving in and out of the first processing chamber 104 and/or the second processing chamber 204. For example, the magnetic element 106 disposed in the first processing chamber 104 and/or the second processing chamber 204 can include a moveable magnet (e.g., a moveable permanent magnet) that can slide in and/or out of the respective processing chamber (e.g., through the port 108 or 208 of the respective processing chamber), in order to collect and/or release the magnetic beads in the fluid, respectively.

As used herein, the term “magnetic field” refers to magnetic influences which create a local magnetic flux that flows through a composition and can refer to field amplitude, squared-amplitude, or time-averaged squared-amplitude. It is to be understood that the magnetic field gradient can be created with a direct-current (DC) magnetic field or alternating-current (AC) magnetic field. The magnetic field strength can range from about 0.00001 Tesla per meter (T/m) to about 10⁵ T/m. In some embodiments, the magnetic field strength can range from about 0.0001 T/m to about 10⁴ T/m. In some other embodiments, the magnetic field strength can range from about 0.001 T/m to about 10³ T/m.

The term “magnetic field gradient” as used herein refers to a variation in the magnetic field with respect to position. By way of example only, a one-dimensional magnetic field gradient is a variation in the magnetic field with respect to one direction, while a two-dimensional magnetic field gradient is a variation in the magnetic field with respect to two directions.

Regardless of the placement of the magnetic element in the system, one or more magnetic elements included in the reciprocating fluid cleansing device and/or systems described herein can enable magnetic separation of magnetic particles (e.g., species-targeting magnetic particles described herein). For example, magnetic particles such as paramagnetic particles can be conjugated with ligands, such as antibodies, proteins, peptides, aptamers, carbohydrates, nucleic acids, lipids, lectins (e.g., but not limited to wild-type and/or recombinant mannan binding lectins (MBLs), or a portion thereof), which bind specific target cells or fragments thereof, particles, molecules or molecular entities present in the fluid to be processed. The magnetic element 106 can be configured to collect the magnetic particles 110 prior to releasing the contents of the first processing chamber 104 to the fluid destination 118. Upon motion of the first movable plunger 102 in a second direction from the second end 120 towards the first end 122 of the fluid cleansing device 100 (e.g., a syringe), a first volume of the fluid from the first processing chamber 104 is transferred to the fluid destination 116. Accordingly, the fluid cleansing process (e.g., for blood cleansing) can be carried out with at least one reciprocating fluid cleansing device described herein, including at least two reciprocating fluid cleansing devices described herein, which can result in a simpler and more cost- and time-efficient fluid cleansing process (e.g., blood cleansing process).

While species-targeting magnetic particles 110 can be added to a fluid sample to be processed before or after the fluid sample enters the first processing chamber 104, the first processing chamber 104 can be additionally or alternatively pre-loaded with species-targeting magnetic particles 110 described herein. Thus, a fluid sample can be directly transferred form a fluid source to the first processing chamber without pre-addition of or dilution by the species-targeting magnetic particles 110. Further, the species-targeting magnetic particles 110 can be recycled for use with a second batch of a fluid to be processed. In some embodiments, the species-targeting magnetic particles 110 can be configured to bind to the pathogens in the fluid from the fluid source 116. An exemplary example of the microbe- or pathogen-targeting magnetic particles or beads 110 includes magnetic mannose-binding lectin (MBL) opsonins such as the ones described in International Pat. App. Pub. Nos. WO 2011/090954 and WO 2013/012924, and U.S. Pat. App. Pub. No. US 2013/0035283, the disclosures of which are incorporated herein by reference. Additional examples of the species-targeting magnetic particles or beads 110 are described hereafter.

Depending on the binding affinity and/or valency of the species-targeting magnetic particles 110, volume of a fluid to be processed, and/or amounts of target species to be removed from the fluid, a skilled artisan can readily determine the amount of the species-targeting magnetic particles 110 pre-loaded in the first processing chamber 104. For example, a concentration of about 10⁴ to about 10¹⁰ species-targeting magnetic particles (e.g., MBL-coated magnetic particles) per mL of a fluid to be processed can be pre-loaded in the first processing chamber 104. In some embodiments, a concentration of about 10⁵- about 10⁹ species-targeting magnetic particles (e.g., MBL-coated magnetic particles) per mL of a fluid to be processed can be pre-loaded in the first processing chamber 104. In other embodiments, a concentration of about 10⁶- about 10⁸ species-targeting magnetic particles (e.g., MBL-coated magnetic particles) per mL of a fluid to be processed can be pre-loaded in the first processing chamber 104. In some embodiments, about 10⁷ species-targeting magnetic particles (e.g., MBL-coated magnetic particles) per mL of a fluid to be processed can be pre-loaded in the first processing chamber 104.

In embodiments of the systems described herein, the system can comprise a reciprocating fluid cleansing device and at least one connector connecting the port of the first processing chamber to the fluid source and the fluid destination. In some embodiments, the system can further comprise at least one tubing or fluid-flowing channel or conduit (e.g., catheter) connecting the port to the fluid source and the fluid destination. For example, movement of the first movable plunger 102 in a first direction towards the second end 120 of the reciprocating fluid cleansing device 100 can cause a predetermined amount of fluid to be transferred from the fluid source 116, via the tubing 115 (e.g., catheter), to the connector 114 and then to the port 108 and into the first processing chamber 104. The movement of the first plunger 102 in a second direction towards the first end 122 can cause the predetermined volume of fluid to be transferred from the port 108 of the first processing chamber 104 to the fluid destination 118 via the connector 114 and the tubing 115 (e.g., catheter).

The connector 114 can be any component that can control a fluid flow into and out of the reciprocating fluid cleansing device described herein, e.g., the direction of the fluid flow and/or flow rates of the fluid. In some embodiments, the connector 114 can direct the direction of a fluid flow. For example, at one time point, the connector 114 can direct a fluid flowing from the first processing chamber 104 to a fluid destination, while at another time point, the connect 114 can direct a fluid flowing from a fluid source to the first processing chamber 104. Examples of a connector can include, without limitations, a multiple-way valve (e.g., 2-way valve or 3-way valve), a flow-splitter, or any other mechanical device configured to split and/or direct the flow into and out of the port 108 such that the flow from the fluid source 116 is directed to the port 108, e.g., via the catheter or tubing 115, and such that the flow from the port 108 of the reciprocating fluid cleansing device 100 is directed to the fluid destination 118, e.g., via the tubing or catheter 115. It can be desirable for the tubing or fluid-flowing channel 115 (e.g., a catheter) to be primed prior to use.

Referring now to FIG. 2, a reciprocating fluid cleansing device is described that includes a first processing chamber 104 with a first movable plunger 102, and a second processing chamber 204 with a second movable plunger 202, wherein the first movable plunger 102 is mechanically coupled to the second movable plunger 202 such that the two movable plungers are moved in a reciprocating manner. The second processing chamber 204 and/or the second movable plunger 202 can include some or all of the various features for first processing chamber 104 and the first movable plunger 102 described herein. For example, as shown in FIG. 2, the second processing chamber can include (i) a port 208 at one end 222 for fluid passage and a second movable plunger 202 (and optionally a second plunger head 224) proximate another end 220. Depending on various applications of the second processing chamber with the second movable plunger, in some embodiments, the second movable plunger can contain no mixing element, and/or the second processing chamber can contain no magnetic element. By way of example only, when the second processing chamber, together with the second movable plunger, is primarily used to regulate the pressure within a fluid system during fluid transfer within the first processing chamber, the magnetic element and/or mixing element needs not be included in the second processing chamber and/or the second movable plunger.

In other embodiments, when the second processing chamber is used to perform a similar function as the first processing chamber, e.g., to remove at least one target species from a fluid source, the second movable plunger 202 can further comprise one or more mixing elements as described earlier. The number and/or types of the mixing element used with the second movable plunger 202 can be substantially similar to or different from the mixing element(s) 112 used with the first movable plunger 102.

In some embodiments, the second movable plunger 202 can include any electrical, mechanical, and/or sensing devices, including, but not limited to, a tachometer wheel, a switch, a potentiometer speed dial, a battery or any combination thereof. In some embodiments, the tachometer wheel can be mounted on an impeller shaft, between the impeller and the motor to enable wireless rpm-measurements using an external laser tachometer, as described in some embodiments for the first movable plunger 102.

In some embodiments, the second processing chamber 204 can further include at least one magnetic element as described herein that is configured to provide a magnetic field gradient within the second processing chamber 204. The number and/or types of the magnetic element(s) included in the second processing chamber can be the same as or different from what is used in the first processing chamber. The magnetic field gradient generated within the second processing chamber can also be the same or different from that generated within the first processing chamber.

The second processing chamber can include an outlet port 208 proximate one end 222 for fluid passage. The outlet port 208 can be coupled to a second connector 214, which can be substantially similar to or different from the first connector 114. The second connector 214 can be a flow splitter, a valve or any other mechanical device configured to connect the outlet port 208 to the fluid source 116 and the fluid destination 118, e.g., via a catheter 215 (e.g., tube). It can be desirable for the tubing or fluid-flowing channel 115 and/or 215 (e.g., a catheter) to be primed prior to use.

In some embodiments, the second processing chamber and the second movable plunger can be substantially similar to the first processing chamber and the first movable plunger. In such embodiments, the reciprocating fluid cleansing device can comprise at least two first processing chambers described herein, each of which includes a first movable plunger mechanically coupled to each other to produce a reciprocating motion. In such embodiments, while a fluid is transferred from a fluid source to one processing chamber for removal of any target species present in the fluid, another processing chamber can transfer a cleansed fluid to a fluid destination, thus enabling a continuous-flow (and closed-loop) fluid cleansing system.

As used herein, the term “mechanically coupled” is intended broadly to encompass both direct and indirect mechanical coupling. Thus, two movable plungers (e.g., the first 102 and the second 202 movable plungers) are mechanically coupled together when they are directly engaged (e.g. by direct contact), or when the first plunger is functionally engaged with an intermediate part (e.g., gears, chains, and/or pulleys) which is functionally engaged either directly or via one or more additional intermediate parts with the second plunger. In some embodiments, two movable plungers can also be considered as mechanically coupled when they are functionally engaged (directly or indirectly) at some times and not functionally engaged at other times. For example, the second movable plunger can be functionally detached from the first movable plunger at some times (e.g., the second movable plunger does not move in response to the motion of the first movable plunger at some times) but can be functionally engaged to the first movable plunger at other times.

The second movable plunger 202 can be mechanically coupled to the first movable plunger 102 such that both plungers are moved in a reciprocating manner. For example, the motion of the first movable plunger 102 to withdraw or transfer a first predetermined amount of fluid from the fluid source 116 simultaneously causes the second movable plunger to dispense or transfer a second predetermined amount of fluid to the fluid destination 118. Similarly, the motion of the first movable plunger 102 to dispense or transfer the first predetermined amount of fluid to the fluid destination 118 simultaneously causes the second movable plunger 202 to withdraw or transfer a new fluid from the fluid source 116. The first and second predetermined amount of fluid can be the same or, alternatively, they can be different, depending, in part, on the size of the processing chambers. By way of example only, as shown in FIG. 2, a first plunger head 124 of the first plunger 102 can be directly coupled to a second plunger head 224 of the second plunger 202. Alternatively, the coupling can be mechanical and/or electrical, and in certain exemplary aspects can include intervening structures to assist the plungers to move simultaneously. In some embodiments, the first plunger and second plunger movements can simply be synchronized to dispense and withdraw the predetermined amount of fluid without any direct connection. For example, the first plunger and the second plunger can be independently controlled by a different fluid controller, e.g., a different fluid delivery pump, such that the movements of the both plungers are synchronized to dispense and withdraw the predetermined amount of fluid without any mechanical coupling.

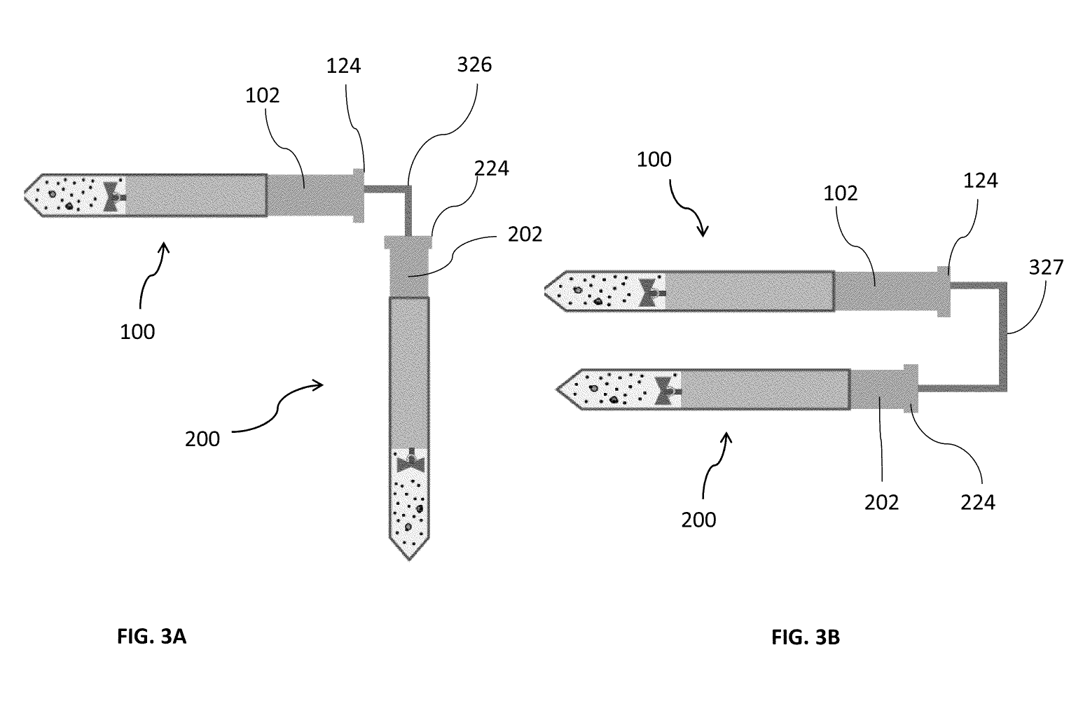

Referring now to FIGS. 3A and 3B, the first plunger head 124 and/or the first plunger body 102 is illustrated being coupled to the second plunger head 224 and/or the second plunger body 202, e.g., via a mechanical means 326 or 327. Any art-recognized methods can be used to mechanically couple two plungers to produce a reciprocating motion. Exemplary methods for mechanically couple two plungers together can include, but are not limited to, the use of a crankshaft, a cord, a line, a chain, a pulley, a gear, a tube, a pipe, or any combinations thereof, to connect the first plunger to second plunger.

Reciprocating motion of the first and second movable plungers can be either linear, i.e., back and forth along a straight-line axis (e.g., as shown in FIG. 2); or angular, i.e., back and forth along a curved, arched or angled axis (e.g., as shown in FIGS. 3A-3B). Where it may be desirable to reduce the footprint of reciprocating fluid cleansing device and/or a system comprising the same, e.g., for use in a portable system, in some embodiments, instead of having two plungers oppositely coupled to each other along a straight-line axis, the two plungers can be mechanically coupled such that they are oriented relative to each other at an angle smaller than 180 degrees (e.g., between about 0 degrees to about 180 degrees, or between about 0 degrees to about 90 degrees). For example, as shown in FIG. 3A, the first plunger head 124 and/or the first plunger body 102 is connected to the second plunger head 224 or the second plunger body 202 with a mechanical means, e.g., a connecting cord 326, such that the first plunger 102 is at a 90 degree angle to the second plunger 202. In another embodiment, as shown in FIG. 3B, the first plunger head 124 and/or the first plunger body 102 can be mechanically connected to the second plunger head 224 and/or the second plunger body 202, e.g., via a connecting cord 327, such that the first plunger 102 is parallel or substantially parallel to the second plunger 202. Those of ordinary skill in the present field of disclosure would appreciate that the first plunger 102 (together with the first processing chamber 104) and the second plunger 202 (together with the second processing chamber 204) can be arranged in a variety of different ways to construct a reciprocating device. Without limitations, for example, in some embodiments, the two plungers can be connected by a mechanical structure, e.g., a cord, that runs through a pulley on a pulley post. Alternatively, while teeth are mounted on a first plunger, one or more gears can be mounted on a connecting structure that is in turn mechanically coupled to a second plunger. In some embodiments, the two plungers can be connected by a U-tube filled with a liquid, e.g., a hydraulic fluid.

In one embodiment, the use of two syringes 100 and 200 mechanically coupled to one another allows for continuous removal of a fluid (e.g., a biological fluid such as blood) from one blood vein or source of a subject and continuous return of the cleansed fluid (e.g., a biological fluid such as blood after removal of a target species such as microbes or molecules) to a different blood vein or destination of the same subject, e.g., in a repeating cycle. Additionally, the reciprocating fluid cleansing device and/or systems described herein can allow magnetically tagging a target species present in the fluid continuously. Accordingly, while, for example, the fluid (e.g., a biological fluid such as blood) is being transferred from the fluid source 116 to the first processing chamber 104, a cleansed fluid (e.g., a biological fluid such as blood after removal of a target species such as microbes or molecules) is being returned from the second processing chamber 204 to the fluid destination 118. The fluid (e.g., a biological fluid such as blood) is mixed, via the mixing element 112 or 212, in the processing chamber 104 or 204 with the species-targeting particles 110, which causes the target species (e.g., pathogens or other contaminants) to bind to the species-targeting magnetic particles.

In general, the capture efficiency of a target species can be increased by mixing a fluid with species-targeting magnetic particles in substantial excess, as compared to an expected amount of target species present in a fluid. For example, the substantial excess in the species-targeting magnetic particles can be at least about 50%, at least about 60%, at least about 70%, at least about 80%, at least about 90%, at least about 95% or higher, more than the expected amount of a target species in a fluid. In some embodiments, the substantial excess in the species-targeting magnetic particles can be at least about 1-fold more, including at least about 1.5-fold, at least about 2-fold, at least about 3-fold, at least about 4-fold, at least about 5-fold, at least about 10-fold, at least about 20-fold, at least about 30-fold, at least about 40-fold, at least about 50-fold, at least about 100-fold or higher, more than the expected amount of a target species in a fluid. In other embodiments, the substantial excess in the species-targeting magnetic particles can be at least about 100-fold, at least about 250-fold, at least about 500-fold, at least about 750-fold, at least about 1000-fold, at least about 2500-fold, at least about 5000-fold, at least about 10.000-fold, at least about 15.000-fold, at least about 20.000-fold or higher, more than the expected amount of a target species in a fluid. The optimal excess of the species-targeting magnetic particles can be established by experiments according to one of skill in the art. For example in some embodiments, the optimal excess of the species-targeting magnetic particles can range from about 10-fold to about 10.000-fold relative to the expected amount of a target species in a fluid.

In certain exemplary aspects of the present disclosure, a fluid is mixed with species-targeting magnetic particles in an amount such that less than about 10%, including less than 9%, less than 8%, less than 7%, less than 6%, less than 5%, less than 4%, less than 3%, less than 2%, less than 1% or lower, of the species-targeting magnetic beads that are present in the processing chamber 104 or 204 have a target species bound to them after a first batch of a fluid is mixed with the species-targeting magnetic particles 110. In some embodiments, a fluid is mixed with species-targeting magnetic particles in an amount such that less than 1%, including less than 0.5%, less than 0.1%, less than 0.05%, less than 0.01% or lower, of the species-targeting magnetic beads that are present in the processing chamber 104 or 204 have a target species bound to them after a first batch of a fluid is mixed with the species-targeting magnetic particles. In one embodiment, a fluid is mixed with species-targeting magnetic particles in an amount such that less than about 0.1% of the species-targeting magnetic particles that are present in the processing chamber 104 or 204 have a target species bound to them after a first batch of a fluid is mixed with the species-targeting magnetic particles 110.

The excess species-targeting magnetic particles can allow for the species-targeting magnetic beads 110 to be re-used multiple times to clean the next volume of fluid introduced into the processing chamber 104 or 204. The number of times that the species-targeting magnetic particles 110 can be re-used to remove a target species from the next volume of fluid into the processing chamber 104 or 204 can vary with, e.g., binding capacity and/or amounts of species-targeting magnetic particles present in the processing chamber, and/or abundance of target species in a fluid. In some embodiments, the species-targeting magnetic beads 110 present in the processing chamber 104 or 204 can be re-used at least about 1 time, at least about 2 times, at least about 3 times, at least about 4 times, at least about 5 times, at least about 10 times or more, before the binding capacity of the species-targeting magnetic 110 beads is saturated. In some embodiments, the species-targeting magnetic beads 110 present in the processing chamber 104 or 204 can be re-used at least about 10 times, at least about 25 times, at least about 50 times, at least about 75 times, at least about 100 times, at least about 250 times, at least about 500 times, at least about 750 times, at least about 1000 times or more, before the binding capacity of the species-targeting magnetic particles 110 is saturated. According to another exemplary aspect, the same species-targeting magnetic particles 110 can be used to cleanse the entire volume of blood of a subject, e.g., a mammalian subject. In one embodiment, the same species-targeting magnetic particles 110 can be used to remove a target species (e.g., but not limited to, microbes or molecules such as toxins) from the entire volume of blood of a subject, e.g., a mammalian subject. Such embodiments can be used to treat a mammalian subject suffering from a microbial infection in blood and/or be used for dialysis in a mammalian subject. A mammalian subject can include a human, a domesticated pet such as cats or dogs, or a laboratory research animal such as mice, rats, rabbits, dogs, and pigs.

In order to be able to re-use the magnetic particles or species-targeting magnetic particles 110, a reciprocating fluid cleansing device and/or a system that allows for the magnetic particles 110 to remain inside the processing chamber 104 or 204 during the transfer of the cleansed fluid from the processing chamber 104 or 204 to the fluid destination 118 would be desirable so as to minimize fluid dilution (e.g., blood dilution). For example, blood dilution in a subject can produce an adverse effect to the subject, e.g., increased morbidity, and such adverse effect can become more prominent in smaller subjects such as children, infants, and/or small animals such as rats or mice. Equipping the reciprocating fluid cleansing devices with one or more magnetic elements 106 can be desirable to allow the species-targeting magnetic beads to remain in the processing chamber 104 or 204 during transfer of the fluid (e.g., blood) to the fluid destination 118.

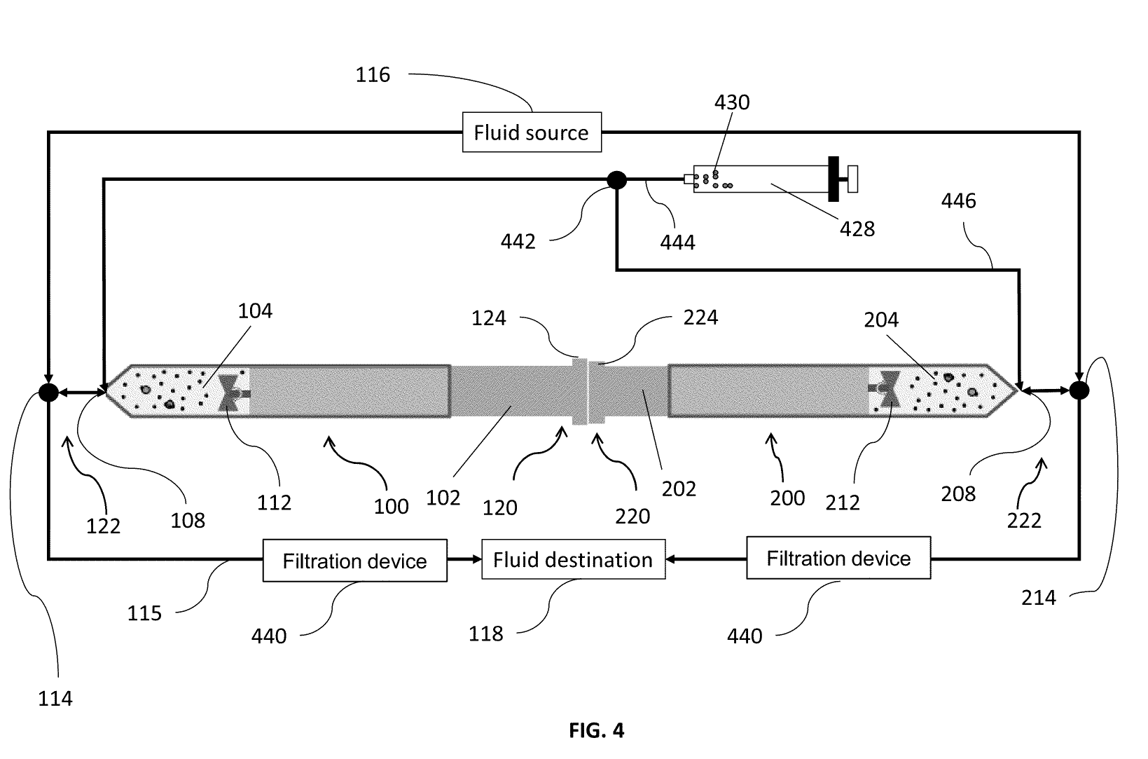

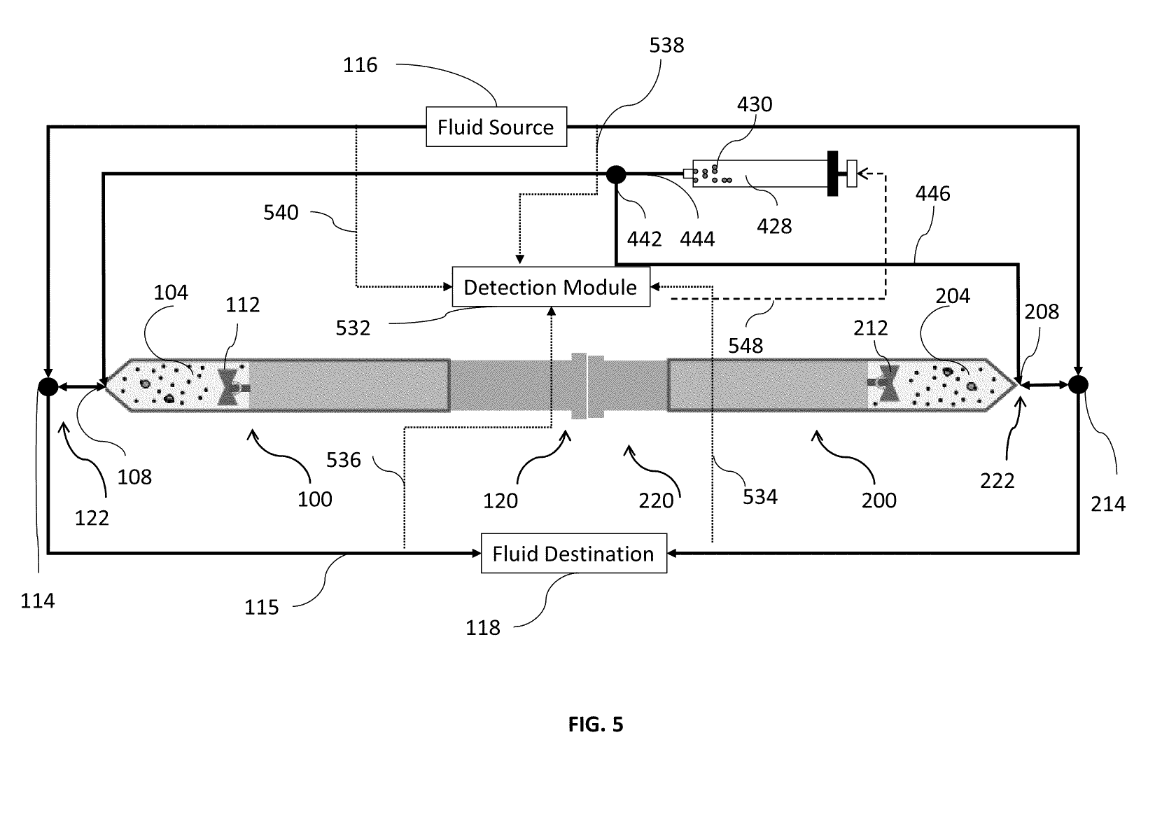

Referring now to FIGS. 4 and 5, in some embodiments, the system described herein can further include at least one detection module 532 for detecting or measuring the level of the target species in the fluid transferred from the fluid source 116 or to the fluid destination 118. The detection module can perform any art-recognized methods to analyze or detect the presence, absence and/or amount of the target species isolated from the fluid aliquot. Examples of analytical and/or detection tools can include, but are not limited to, microscopy, spectroscopy, immunostaining, electrochemical detection, polynucleotide detection, fluorescence anisotropy, fluorescence resonance energy transfer, electron transfer, enzyme assay, magnetism, electrical conductivity, isoelectric focusing, chromatography, immunoprecipitation, immunoseparation, aptamer binding, filtration, electrophoresis, use of a CCD camera, immunoassay, polymerase chain reaction (PCR), mass spectroscopy, or substantially any combination thereof. Detection, such as cell detection, can be carried out using light microscopy with phase contrast imaging and/or fluorescence microscopy based on the characteristic size, shape and refractile characteristics of specific cell types. Greater specificity can be obtained using optical imaging with fluorescent or cytochemical stains that are specific for individual cell types or microbes.

In one embodiment, an aliquot from a fluid source 538, 540 can be transferred to a detection module 532 for detecting the presence or absence, and/or measuring the level of the target species in the aliquot. Similarly, an aliquot leaving the reciprocating fluid cleansing device or from a fluid destination 534, 536 can be transferred to the detection module 532 for detecting or measuring the level of the target species in the aliquot. Thus, the capture or cleansing efficiency of a reciprocating fluid cleansing device or system described herein can be determined or monitored by comparing the levels of target species in an aliquot obtained from the fluid source (prior to entering a reciprocating fluid cleansing device described herein) with that in another aliquot obtained after leaving the reciprocating fluid cleansing device (prior to entering the fluid destination) or from the fluid destination.

If the capture or cleansing efficiency of a reciprocating fluid cleansing device or a system described herein is decreasing over time, this can be an indicator of species-targeting magnetic particles being saturated. In such embodiments, the species-targeting magnetic particles can be regenerated, e.g., by flowing a regenerating medium (e.g., an acid) into the processing chamber containing the saturated species-targeting magnetic particles. In these embodiments, it can be desirable that the reciprocating fluid cleansing device be disconnected from the fluid source and fluid destination during regeneration of the species-targeting magnetic particles. Alternatively, the saturated species-targeting magnetic particles can be removed from the processing chamber, e.g., by flowing a buffered solution to wash the saturated species-targeting magnetic particles out from the processing chamber and collecting them for regeneration. The processing chamber can then be replenished with fresh species-targeting magnetic particles, e.g., by flowing a carrier medium containing fresh species-targeting magnetic particles from the supply chamber 428 into the processing chamber 104 and/or 204, and then removing the carrier medium from the processing chamber in the presence of a magnetic field gradient, which can immobilize the fresh species-targeting magnetic particles inside the processing chamber.

In some embodiments, the detection module 532 can perform various art-recognized assays to determine or identify which or what types of target species are present in the fluid transferred from the fluid source 538, 540, the detection module 532 can then make a determination as to which species-targeting magnetic particles 430 need to be released to the processing chamber 104 and/or 204. The detection module 532 can then be configured to send a signal 548 to the supply chamber 428 to transfer to the processing chamber 104 and/or 204 the particular species-targeting magnetic particles 430. The supply chamber 428 can be configured to hold one or a variety of (e.g., at least two or more) species-targeting magnetic particles 430. The supply chamber 428 can be configured to release one of the varieties of species-targeting particles 430 to the port 108 or 208 via a connector 442 and tubing 446 depending on the signal 548 received from the detection module 532.

While it may not be necessary, in some embodiments, the supply chamber 428 can be configured to supply the fluid from the fluid source 116 with a plurality of fresh species-targeting magnetic particles 430. The supply chamber 428 can be configured to periodically supply the fluid from the fluid source 116, prior to entering the first processing chamber 104 or the second processing chamber 204, with a plurality of fresh species-targeting magnetic particles 430. Once the species-targeting magnetic particles 430 are transferred to the processing chamber 104 and/or 204 via the corresponding port 108 and/or 208, the motorized mixing element 112 or 212 can be activated so that it mixes the fluid in the first processing chamber 104 and/or the second processing chamber 204 with the species-targeting magnetic particles 110 and/or 430.

While it may not be necessary, in some embodiments, the system described herein can further comprise at least one or more (e.g., 1, 2, 3 or more) filtration devices 440 (as shown in FIG. 4) fluidically connecting between the connector 114 and/or 214 and fluid destination 118. The filtration device 440 permits processing of the fluid exiting from the first processing chamber 104 and/or the second processing chamber 204 to remove any remaining magnetic particles present in the fluid. Thus, the filtration device 440 can be a device configured to remove or separate any remaining magnetic particles from a fluid by any methods known in the art. For example, the filtration device 440 can be configured to remove or separate magnetic particles from the fluid by physical entrapment and/or application of a magnetic field gradient. In some embodiments, the filtration device 440 can be configured and/or fluidically connected such that the fluid can re-circulate back into the device more than once, e.g., at least two times, at least three times or more, to ensure that substantially all the magnetic particles or species-targeting magnetic particles are removed from the fluid before reaching the fluid destination.

As used herein, the term “fluidically connected” or “fluidically connecting” generally refers to two or more devices and/or modules connected in an appropriate manner such that a fluid can pass or flow from one device or module to the other device or module. When two or more devices and/or modules are fluidically connected together, additional devices and/or modules can be present between the two or more devices and/or modules. For example, two or more devices and/or modules can be fluidically connected together by having one or more detection modules (e.g., modules(s) detecting the presence and/or absence and/or level of a target species and/or magnetic particles in a fluid) present between the two or more devices and/or modules. Alternatively, the two or more devices and/or modules can be connected such that a fluid can pass or flow directly from a first device or module to a second device or module without any intervening devices or modules. Two or more devices or modules can be fluidically connected, for example, by connecting an outlet of a first device or module to an inlet of a second device or module using tubing, a conduit, a channel, piping or any combinations thereof.

In some embodiments, sensors can also be integrated into the exemplary systems described above to provide real-time feedback that the binding of the target species to the species-targeting magnetic particles has occurred.

### Kits

In one aspect, provided herein relates to kits, which can be used, e.g., for removing or separating at least one target species from a fluid. The kit comprises (i) a reciprocating fluid cleansing device described herein or a movable plunger described herein that is adapted to use with a conventional medical fluid delivery device such as a syringe; and (ii) at least one type of the species-targeting magnetic particles described herein.

In some embodiments, the kit can comprise a plurality of (e.g., at least 2 or more, including, e.g., at least 3, at least 4, at least 5, at least 6, at least 7, at least 8, at least 9, at least 10, at least 15, at least 20 or more) the reciprocating fluid cleansing devices or movable plungers.

For embodiments where the kit provides movable plunger(s), a user can fit the provided movable plunger into the barrel of a conventional medical fluid delivery device such as a syringe (which acts as the processing chamber as defined herein) to perform different embodiments of the methods.

In some embodiments, the species-targeting magnetic particles can be pre-loaded into the reciprocating fluid cleaning device described herein. In some embodiments, the species-targeting magnetic particles can be provided in a separate container. In one embodiment, the species-targeting magnetic particles comprise pathogen-targeting magnetic particles. In one embodiment, the pathogen-targeting magnetic particles are FcMBL-coated magnetic particles as described in U.S. Pat. App. Pub. No. US 2013/0035283 and International Pat. App. Pub. No. WO 2013/012924, the contents of which are incorporated herein by reference.

In some embodiments, the kit can further comprise at least one tubing or catheter. The tubing or catheter can be used to connect the port of the reciprocating fluid cleansing device to a fluid source and a fluid destination.

In some embodiments, the kit can further comprise at least one or a plurality of (e.g., 2 or more) disposable or detachable mixing elements described herein, e.g., disposable or detachable impellers as shown in FIG. 6. Thus, a user can use different mixing elements for various applications, e.g., low-shear mixing or high-shear mixing applications.

In some embodiments, the kit can further comprise a reagent employed in the method described herein, e.g., but not limited to, a regenerating medium, a buffered solution (e.g., for reconstitution of the species-targeting magnetic particles and/or priming the tubing or catheter), a detection agent for target species (e.g., a labeling agent such as a dye), or any combinations thereof.

In addition to the above mentioned components, any embodiments of the kits described herein can include informational material. The informational material can be descriptive, instructional, marketing or other material that relates to the methods described herein and/or the use of the components in the kit for the methods described herein. For example, the informational material can describe methods for using the kits provided herein to remove a target species from a fluid (e.g., removing pathogens such as bacteria from blood of a subject). The kit can also include an empty container and/or a delivery device, e.g., which can be used to deliver a test sample to a sample container. The informational material of the kits is not limited in its form. In many cases, the informational material, e.g., instructions, is provided in printed matter, e.g., a printed text, drawing, and/or photograph, e.g., a label or printed sheet. However, the informational material can also be provided in other formats, such as Braille, computer readable material, video recording, or audio recording. In another embodiment, the informational material of the kit is a link or contact information, e.g., a physical address, email address, hyperlink, website, or telephone number, where a user of the kit can obtain substantive information about the formulation and/or its use in the methods described herein. The informational material can also be provided in any combination of formats.

In some embodiments, the kit can contain separate containers, dividers or compartments for each component and informational material. For example, each different component can be contained in a bottle, vial, or syringe, and the informational material can be contained in a plastic sleeve or packet. In other embodiments, the separate elements of the kit are contained within a single, undivided container. For example, a collection of the species-targeting magnetic particles is contained in a bottle, vial or syringe that has attached thereto the informational material in the form of a label.

### Methods of Use

Different embodiments of the reciprocating fluid cleansing devices, systems and/or kits described herein can be used in various applications to separate or remove one or more target species from a fluid source, while maintaining continuous flow. A fluid source can include, but are not limited to, a biological source (e.g., a biological fluid from a subject), an environmental source (e.g., wastewater from a wastewater treatment plant), and a processing plant (e.g., pharmaceutical and/or food/beverage manufacturing and/or processing plants). Exemplary applications can include, but are not limited to, cleansing an infected biological fluid in a subject; performing a dialysis in a subject (e.g., to remove molecules such as toxins from a biological fluid of a subject); removing a contaminant from a pharmaceutical process and/or fluid materials used to make pharmaceutical products, food and/or beverages; removing a contaminant from wastewater in a wastewater treatment, water filter; isolating and/or purifying a target species from a fluid; and any applications that involves removal or separation of a target species from a fluid.

Accordingly, methods for removing or separating a target species from a fluid are also provided herein. In some embodiments, the method comprises (a) providing a system or a reciprocating device described herein; (b) transferring, in the absence of a first magnetic field gradient, a first volume of a fluid from the fluid source 116 into the first processing chamber 104; (c) activating the mixing element 112 (e.g., motorized mixing element) of the first processing chamber 104 to mix the first volume of the fluid loaded in the first processing chamber with a first plurality of species-targeting magnetic particles 110, wherein at least a portion of the first plurality of the species-targeting magnetic particles 110 bind to the target species present in the first volume of the fluid; (d) activating the magnetic element 106 of the first processing chamber 104 to generate the first magnetic field gradient for separating the first plurality of the species-targeting magnetic particles 110 (bound or unbound with the target species) from the first volume of the fluid to yield a first magnetic particle-free fluid; and (e) transferring, in the presence of the first magnetic field gradient 106, the first magnetic particle-free fluid to the fluid destination 118; thereby removing or separating the target species from the first volume of the fluid. By repeating items (b)-(e) of the method described herein multiple times, a desired volume of the fluid can be processed or cleansed continuously.

As used herein, the term “magnetic particle-free fluid” refers to a fluid exiting from the first processing chamber and/or the second processing chamber after exposure to a magnetic field gradient to separate magnetic particles (e.g., bound and unbound species-targeting magnetic particles) from the fluid. The magnetic particle-free fluid can contain a negligible amount of magnetic particles (e.g., bound and unbound species-targeting magnetic particles), or an amount of the magnetic particles (e.g., bound and unbound species-targeting magnetic particles) that produces no adverse effect (e.g., no toxic effect) to a subject or an environment. For example, in some embodiments, the magnetic particle-free fluid can contain magnetic particles (e.g., bound and unbound species-targeting magnetic particles) with a concentration of no more than 10 ppm, no more than 5 ppm, no more than 1 ppm, no more than 0.5 ppm, no more than 0.1 ppm or lower. In one embodiment, the magnetic particle-free fluid can contain substantially no magnetic particles (e.g., bound and unbound species-targeting magnetic particles).

In some embodiments, the magnetic particle-free fluid exiting from the first processing chamber and/or the second processing chamber can be directed to at least one filtration device 440 (as shown in FIG. 4) prior to the fluid destination. The filtration device 440 can be a device that is configured to remove or separate any remaining magnetic particles from the fluid by any methods known in the art. For example, the filtration device 440 can remove or separate magnetic particles from the fluid by physical entrapment and/or application of a magnetic field gradient. In some embodiments, the magnetic particle-free fluid can pass through the filtration device 440 more than once, e.g., twice or more, by re-circulating back to the filtration device, and/or pass through a series of the filtration devices 440 (e.g., at least two or more filtration devices arranged in a series) before reaching the fluid destination.

In some embodiments, a method for removing a target species from a fluid source comprises (a) providing one or more embodiments of a system described herein, which comprises a mixer device adapted to connect between the fluid source and the first processing chamber; (b) transferring, in the absence of a first magnetic field gradient, a first volume of a fluid from the fluid source and a first plurality of species-targeting magnetic particles through the mixer device into the first processing chamber; wherein the mixer device is activated to mix the first volume of the fluid with the first plurality of species-targeting magnetic particles, wherein at least a portion of the first plurality of the species targeting magnetic particles bind to the target species present in the first volume of the fluid; (c) activating the magnetic element of the first processing chamber to generate the first magnetic field gradient for separating the first plurality of the species-targeting magnetic particles from the first volume of the fluid to yield a first magnetic particle-free fluid; and (d) transferring, in the presence of the first magnetic field gradient, the first magnetic particle-free fluid to the fluid destination; thereby removing the target species from the first volume of the fluid.

In some embodiments where the mixer device can comprise on its surface species-targeting molecules, the method described herein can be performed without a magnetic field gradient. Thus, in some embodiments, the method for removing a target species from a fluid source can comprise (a) providing one or more embodiments of a system described herein, which comprises a mixer device adapted to connect between the fluid source and the first processing chamber; wherein the mixer device comprises on its surface species-targeting molecules; (b) transferring a first volume of a fluid from the fluid source through the mixer device into the first processing chamber; wherein the mixer device is activated to mix the first volume of the fluid with the species-targeting molecules, and wherein the target species present in the first volume of the fluid binds to at least a portion of the species targeting molecules; thereby generating a first cleansed fluid; (c) transferring the first cleansed fluid to the fluid destination; thereby removing the target species from the first volume of the fluid.

A fluid can be transferred from the fluid source or to the fluid destination at any rate. In some embodiments, the fluid can be transferred from the fluid source at a flow rate different from the flow rate of a fluid transferred to the fluid destination. In other embodiments, the fluid can be transferred from the fluid source at a flow rate substantially same as the flow rate of a fluid transferred to the fluid destination. The flow rate can vary depending on, e.g., the size of the processing chambers, and/or volume of a fluid to be processed. In some embodiments, the flow rate can range from about 50 mL/hr to about 1000 mL/hr, from about 100 mL/hr to about 800 mL/hr, from about 200 mL/hr to about 600 mL/hr. In other embodiments, the flow rate can range from about 1000 mL/hr to about 5000 mL/hr, or from about 1500 mL/hr to about 3000 mL/hr. Without wishing to be bound, the flow rate can be lower than 50 mL/hr or higher than 5000 mL/hr. The flow rate of a fluid can be controlled by any art-recognized methods, e.g., using a pump, and/or valves.

Any volume of a fluid can be transferred into the first and/or second processing chamber, e.g., a volume no more than the maximum fluid capacity of the processing chamber. By way of example only, if the processing chamber is a typical syringe barrel, the volume of a fluid that can be transferred into the syringe barrel each time can range from about 0.1 mL to about 60 mL, from about 0.5 mL to about 50 mL, or from about 1 mL to about 40 mL. In other embodiments, the volume of a fluid transferred to the first and/or second processing chamber can be larger than 60 mL when a larger processing chamber larger than 60 mL is used.

In some embodiments, the reciprocating device used in the method described herein can be pre-loaded with a plurality of species-targeting magnetic particles. In general, the reciprocating device can be pre-loaded with species-targeting magnetic particles in excess relative to an expected amount of target species present in a fluid to be processed. For example, in one embodiment, the reciprocating device can be pre-loaded with species-targeting magnetic particles in an amount of about 10-fold to about 10.000-fold in excess relative to an expected amount of target species present in a fluid to be processed. Stated another way, in some embodiments, the reciprocating device can be pre-loaded with a concentration of about 10⁴-10¹⁰ species-targeting magnetic particles (e.g., MBL-coated magnetic particles) per mL of a fluid to be processed. In other embodiments, the reciprocating device can be pre-loaded with a concentration of about 10⁵- about 10⁹ species-targeting magnetic particles (e.g., MBL-coated magnetic particles) per mL of a fluid to be processed. In other embodiments, the reciprocating device can be pre-loaded with a concentration of about 10⁶- about 10⁸ species-targeting magnetic particles (e.g., MBL-coated magnetic particles) per mL of a fluid to be processed. In one embodiment, the reciprocating device can be pre-loaded with a concentration of about 10⁷ species-targeting magnetic particles (e.g., MBL-coated magnetic particles) per mL of a fluid to be processed.

In some embodiments where the reciprocating device is not pre-loaded with species-targeting magnetic particles, the method can further comprise adding the first plurality of the species-targeting magnetic particles to the first volume of the fluid. In one embodiment, the species-targeting magnetic particles can be added to the first volume of the fluid prior to the first volume of the fluid entering the first processing chamber. In another embodiment, the species-targeting magnetic particles can be added to the first volume of the fluid after the first volume of the fluid entering the first processing chamber. In other embodiments, the method can further comprise adding the plurality of the species-targeting magnetic particles to the second volume of the fluid. In one embodiment, the species-targeting magnetic particles can be added to the second volume of the fluid prior to the second volume of the fluid entering the second processing chamber. In another embodiment, the species-targeting magnetic particles can be added to the second volume of the fluid after the second volume of the fluid entering the second processing chamber.

Amounts of the species-targeting magnetic particles added into the fluid can vary with a number of factors including, but not limited to, binding capacity and strength of species-targeting magnetic particles, abundance of target species in a fluid, flow rate of the fluid, mixing time of the species-targeting magnetic particles, and any combinations thereof. In some embodiments, the species-targeting magnetic particles can be added in substantial excess, as compared to an expected amount of target species present in a fluid (e.g., to increase the capture efficiency of the target species). For example, the substantial excess in the species-targeting magnetic particles can be at least about 50%, at least about 60%, at least about 70%, at least about 80%, at least about 90%, at least about 95% or higher, more than the expected amount of a target species in a fluid. In some embodiments, the substantial excess in the species-targeting magnetic particles can be at least about 1-fold more, including at least about 1.5-fold, at least about 2-fold, at least about 3-fold, at least about 4-fold, at least about 5-fold, at least about 10-fold, at least about 20-fold, at least about 30-fold, at least about 40-fold, at least about 50-fold, at least about 100-fold or higher, more than the expected amount of a target species in a fluid. In other embodiments, the substantial excess in the species-targeting magnetic particles can be at least about 100-fold, at least about 250-fold, at least about 500-fold, at least about 750-fold, at least about 1000-fold, at least about 2500-fold, at least about 5000-fold, at least about 10.000-fold, at least about 15.000-fold, at least about 20.000-fold or higher, more than the expected amount of a target species in a fluid. The optimal excess of the species-targeting magnetic particles can be established by experiments according to one of skill in the art. For example in some embodiments, the optimal excess of the species-targeting magnetic particles can range from about 10-fold to about 10.000-fold relative to the expected amount of a target species in a fluid.

The excess species-targeting magnetic particles can allow for the species-targeting magnetic beads 110 to be re-used multiple times to clean the next volume of fluid introduced into the processing chamber 104 or 204. The number of times that the species-targeting magnetic particles 110 can be re-used to remove a target species from the next volume of fluid into the processing chamber 104 or 204 can vary with, e.g., binding capacity and/or amounts of species-targeting magnetic particles present in the processing chamber, and/or abundance of target species in a fluid. In some embodiments, the species-targeting magnetic beads 110 present in the processing chamber 104 or 204 can be re-used at least about 1 time, at least about 2 times, at least about 3 times, at least about 4 times, at least about 5 times, at least about 10 times or more, before the binding capacity of the species-targeting magnetic 110 beads is saturated. In some embodiments, the species-targeting magnetic beads 110 present in the processing chamber 104 or 204 can be re-used at least about 10 times, at least about 25 times, at least about 50 times, at least about 75 times, at least about 100 times, at least about 250 times, at least about 500 times, at least about 750 times, at least about 1000 times or more, before the binding capacity of the species-targeting magnetic particles 110 is saturated. In some embodiments, the same species-targeting magnetic particles 110 can be used to cleanse the entire volume of blood of a subject, e.g., a mammalian subject. In one embodiment, the same species-targeting magnetic particles 110 can be used to remove a target species (e.g., but not limited to, microbes or molecules such as toxins) from the entire volume of blood of a subject, e.g., a mammalian subject. Such embodiments can be used to treat a mammalian subject suffering from a microbial infection in blood and/or be used for dialysis in a mammalian subject. A mammalian subject can include a human, a domesticated pet such as cats or dogs, or a laboratory research animal such as mice, rats, rabbits, dogs, and pigs.

To facilitate the binding of target species to species-targeting magnetic particles, the mixing element of the first reciprocating fluid cleansing device can be activated or turned on to promote the mixing of the fluid with species-targeting magnetic particles, e.g., by mechanical mixing with an impeller and/or electromagnetic mixing with at least two electromagnets placed opposite on either side of the mixing region of the processing chamber 104. In some embodiments, the method can further comprise activating the motorized mixing element of the second processing chamber to mix the second volume of the fluid loaded in the second processing chamber with a second plurality of species-targeting magnetic particles, wherein at least a portion of the second plurality of the species-targeting magnetic particles bind to the target species present in the second volume of the fluid.

The mixing time of the fluid with species-targeting particles by a mixing element described herein can generally range from seconds, minutes, hours, to days, depending on, e.g., but not limited to, the volume of the fluid to be processed, and/or mixing speed. In some embodiments, the mixing time can range from about 30 seconds to about 1 hour, from about 1 min to about 45 mins, or from about 5 mins to about 30 mins. In some embodiments, the mixing time can be at least about 1 hour, at least about 2 hours, at least about 3 hours, at least about 6 hours, at least about 12 hours, at least about 24 hours or longer. In other embodiments, the mixing time can be at least about 1 day, at least about 2 days, at least about 3 days, at least about 4 days, at least about 5 days, or longer. In one embodiment, the mixing time can vary from about 5 mins to about 30 mins.

When a fluid enters a processing chamber 104 or 204 of a reciprocating device and/or a system described herein and mixes with species-targeting magnetic particles, at least a portion of the target species can bind to the species-targeting magnetic particles. For example, at least about 30%, including at least about 40%, at least about 50%, at least about 60%, at least about 70%, at least about 80%, or higher, of the target species present in a fluid can bind to the species-targeting magnetic particles. In some embodiments, at least about 85%, at least about 90%, at least about 95%, at least about 98%, at least about 99%, up to and including 100%, of the target species present in a fluid can bind to the species-targeting magnetic particles. In one embodiment, 100% of the target species present in the fluid binds to the species-targeting magnetic particles.

The magnetic particles bound with target species isolated from a fluid can be removed from the fluid by immobilizing the magnetic particles within the processing chamber with a magnetic field gradient. Thus, the magnetic element of the first processing chamber can be placed in close proximity to the first processing chamber or be activated or turned on to generate a magnetic field gradient sufficient to separate the species-targeting magnetic particles from the fluid contained in the first processing chamber, thus yielding a magnetic particle-free fluid or cleansed fluid. In some embodiments, the method can further comprise placing a magnetic element in close proximity to the second processing chamber and/or activating a magnetic element of the second processing chamber to generate a second magnetic field gradient sufficient to separate the second plurality of the species-targeting magnetic particles from the second volume of the fluid to yield a second magnetic particle-free fluid, thereby removing the target species from the second volume of the fluid. The magnetic field gradient can be created with a direct-current (DC) magnetic field or alternating-current (AC) magnetic field. The magnetic field strength can range from about 0.00001 Tesla per meter (T/m) to about 10⁵ T/m. In some embodiments, the magnetic field strength can range from about 0.0001 T/m to about 10⁴ T/m. In some other embodiments, the magnetic field strength can range from about 0.001 T/m to about 10³ T/m.

In some embodiments, the method can further comprise regenerating the species-targeting magnetic particles that are saturated with bound target species, e.g., after processing a number of volumes of the fluid. In one embodiment, the species-targeting magnetic particles can be regenerated by flowing a regenerating medium (e.g., an acid or any art-recognized regenerating medium) into the processing chamber containing saturated species-targeting magnetic particles. In some embodiments, it can be desirable to disconnect the system and/or device described herein from the fluid source and fluid destination prior to flowing a regenerating medium into the processing chamber, e.g., to avoid contaminating the fluid source and fluid destination. In other embodiments, the method can further comprise removing the saturated species-targeting magnetic particles from the processing chamber, e.g., by flowing a buffered solution to wash the saturated species-targeting magnetic particles out from the processing chamber and collecting them for subsequent regeneration.

In some embodiments, the method can further comprise replenishing the processing chamber with fresh species-targeting magnetic particles, e.g., by flowing a carrier medium containing fresh species-targeting magnetic particles, e.g., from the supply chamber 428, into the processing chamber. In some embodiments, the carrier medium can be removed from the processing chamber by immobilizing the fresh species-targeting magnetic particles inside the processing chamber in the presence of the magnetic field gradient. The amount of the species-targeting magnetic particles added to the processing chamber can vary, e.g., depending, in part, on the volume of the fluid to be processed and/or expected amounts of target species to be removed or separated from the fluid. For example, fresh species-targeting magnetic particles can be added in an equal amount of used or saturated species-targeting magnetic particles removed from the processing chamber, e.g., for regeneration. In some embodiments, fresh species-targeting magnetic particles can be added in a substantial excess, as compared to an expected amount of target species present in a fluid (e.g., to increase the capture efficiency of the target species).

In some embodiments, the species-targeting magnetic molecules bound with a target species can be collected for analysis, e.g., identification, characterization, culturing (if target species are cells) and/or quantitation of the target species. The target species can remain bound on or be detached from the species-targeting magnetic molecules for various analyses, which involve, for example, but not limited to, microscopy, spectroscopy, immunostaining, electrochemical detection, polynucleotide detection, fluorescence anisotropy, fluorescence resonance energy transfer, electron transfer, enzyme assay, magnetism, electrical conductivity, isoelectric focusing, chromatography, immunoprecipitation, immunoseparation, aptamer binding, filtration, electrophoresis, use of a CCD camera, immunoassay, polymerase chain reaction (PCR), mass spectroscopy, or any combination thereof. Detection, such as cell detection, can be carried out using light microscopy with phase contrast imaging and/or fluorescence microscopy based on the characteristic size, shape and refractile characteristics of specific cell types. Greater specificity can be obtained using optical imaging with fluorescent or cytochemical stains that are specific for individual cell types or microbes.

In some embodiments, the method can further comprise selecting an additional treatment and/or administering the treatment to a fluid source (e.g., a subject or an environment), based on the analyses of the target species collected from the fluid.

In some embodiments, a plurality of reciprocating fluid cleansing devices can be employed in the method and/or system described herein. For example, at least 2, at least 3, at least 4, at least 5, at least 6 or more reciprocating fluid cleansing devices can be employed in the method/system described herein.

Treatment of Blood Diseases or Disorders (e.g., Sepsis):

In some embodiments, the systems, devices, kits and/or methods described herein can be used to treat blood diseases or disorders, e.g., pathogen-causing blood diseases or disorders such as sepsis. In one aspect, methods for treating a blood diseases or disorders (e.g., pathogen-causing blood diseases or disorders such as sepsis) are provided herein. The method comprises (a) providing a system, a reciprocating device or a kit described herein; (b) transferring, in the absence of a first magnetic field gradient, a first volume of blood from at least one blood vein of a subject into the first processing chamber; (c) activating the motorized mixing element of the first processing chamber to mix the first volume of the blood loaded in the first processing chamber with a first plurality of pathogen-targeting magnetic particles, wherein at least a portion of the first plurality of the pathogen-targeting magnetic particles bind to the pathogens present in the first volume of the blood; (d) activating the magnetic element of the first processing chamber to generate the first magnetic field gradient for separating the first plurality of the pathogen-targeting magnetic particles from the first volume of the blood to yield a first magnetic particle-free fluid; and (e) transferring, in the presence of the first magnetic field gradient, the first magnetic particle-free fluid to another blood vein of the subject; thereby removing the pathogens from the first volume of the blood. The processes (b)-(e) can be repeated until substantially all the pathogens present in the blood are removed. In one embodiment, the methods described herein can be used to treat sepsis.

In some embodiments, the pathogen-targeting magnetic particles are magnetic particles coated with microbe-targeting molecules (e.g., but not limited to, FcMBL-coated magnetic particles) as described in U.S. Pat. App. Pub. No. US 2013/0035283 and International Pat. App. Pub. No. WO 2013/012924, the contents of which are incorporated herein by reference. For example, FcMBL-coated magnetic particles can bind to pathogens that cause blood infections (e.g., sepsis). In one embodiment, the methods described herein can be used to treat sepsis.

In some embodiments, the method can further comprising administering a therapeutic agent (e.g., but not limited to an antimicrobial agent such as an antibiotic) to the subject.

### Target Species

The reciprocating fluid cleansing devices, systems, kits and/or methods described herein can be used to capture or isolate one or more target species from a fluid sample or a fluid source. In some embodiments, one target species can be captured from a fluid sample or a fluid source using a single reciprocating fluid cleansing device or system described herein. In other embodiments, two or more target species, e.g., at least two, at least three, at least four, at least five, at least six, at least seven, at least eight, at least nine, at least ten or more target species, can be captured in one or more reciprocating fluid cleansing devices or a system described herein. For example, different species-targeting magnetic particles can be mixed with a fluid volume to be processed in the processing chamber described herein. In some embodiments, different reciprocating fluid cleansing device can be run in parallel and used to capture a different or the same target species from a fluid source.

As used herein, the term “target species” refers to any molecule, cell or particulate that is to be separated or isolated from a fluid source. Representative examples of target cellular species include, but are not limited to, mammalian cells, viruses, bacteria, fungi, yeast, protozoan, microbes, parasites, and cellular components thereof. As used herein, the term “a cellular component” in reference to cells and/or microbes is intended to include any component of a cell that can be at least partially isolated from the cell, e.g., upon lysis of the cell. Cellular components can include, but are not limited to, organelles, such as nuclei, perinuclear compartments, nuclear membranes, mitochondria, chloroplasts, or cell membranes; polymers or molecular complexes, such as lipids, polysaccharides, proteins (membrane, trans-membrane, or cytosolic); nucleic acids, viral particles, or ribosomes; or other molecules, such as hormones, ions, and cofactors.

Representative examples of target molecules include, but are not limited to, hormones, growth factors, cytokines (e.g., inflammatory cytokines), proteins, peptides, prions, lectins, oligonucleotides, carbohydrates, lipids, exosomes, contaminating molecules and particles, and molecular and chemical toxins. The target species can also include contaminants found in non-biological fluids, such as pathogens or lead in water or in petroleum products. Parasites can include organisms within the phyla Protozoa, Platyhelminthes, Aschelminithes, Acanthocephala, and Arthropoda.

As used herein, the term “cytokine” can refer to any small cell-signaling protein molecule that is secreted by a cell of any type. Cytokines can include proteins, peptides, and/or glycoproteins. Based on their function, cell of secretion, and/or target of action, cytokines can be generally classified as lymphokines, interleukins, and chemokines. The term “lymphokines” as used herein generally refers to a subset of cytokines that are produced by a type of immune cell known as a lymphocyte. The term “interleukins” as used herein generally refers to cytokines secreted and/or synthesized by leukocytes and helper CD4+ T lymphocytes, and/or through monocytes, macrophages, and/or endothelial cells. In some embodiments, interleukins can be human interleukins including IL-1, IL-2, IL-3, IL-4, IL-5, IL-6, IL-7, IL-8, IL-9, IL-10, IL-11, IL-12, IL-13, IL-14, IL-15, IL-16, IL-17, IL-18, IL-19, IL-20, IL-21, IL-22, IL-23, IL-24, IL-25, IL-26, IL-27, IL-28, IL-29, IL-30, IL-31, IL-32, IL-33, IL-34, and IL-35. The term “chemokine” as used herein generally refers to a specific class of cytokines that mediates chemoattraction (chemotaxis) between cells. Examples of chemokines include, but are not limited to, CCL family, CXCL family, CX3CL family and XCL family.

The term “inflammatory cytokine” as used herein generally includes, without limitation, a cytokine that stimulates an inflammatory response. Examples of inflammatory cytokines include, without limitation, IFN-γ, IL-1β, and TNF-α.

As used herein, the term “hormone” can refer to polypeptide hormones, which are generally secreted by glandular organs with ducts. Included among the hormones are, for example, growth hormone such as human growth hormone, N-methionyl human growth hormone, and bovine growth hormone; parathyroid hormone; thyroxine; insulin; proinsulin; relaxin; estradiol; androgens such as calusterone, dromostanolone propionate, epitiostanol, mepitiostane, or testolactone; prorelaxin; glycoprotein hormones such as follicle stimulating hormone (FSH), thyroid stimulating hormone (TSH), and luteinizing hormone (LH); prolactin, placental lactogen, mouse gonadotropin-associated peptide, gonadotropin-releasing hormone; inhibin; activin; mullerian-inhibiting substance; and thrombopoietin. As used herein, the term hormone includes proteins from natural sources or from recombinant cell culture and biologically active equivalents of the native-sequence hormone, including synthetically produced small-molecule entities and pharmaceutically acceptable derivatives and salts thereof.

The term “growth factor” as used herein can refer to proteins that generally promote growth, and include, for example, hepatic growth factor; fibroblast growth factor; vascular endothelial growth factor; nerve growth factors such as NGF-13; platelet-derived growth factor; transforming growth factors (TGFs) such as TGF-α and TGF-β; insulin-like growth factor-I and -II; erythropoietin (EPO); osteoinductive factors; interferons such as interferon-α, -β, and -γ; and colony stimulating factors (CSFs) such as macrophage-CSF (M-CSF); granulocyte-macrophage-CSF (GM-CSF); and granulocyte-CSF (G-CSF). As used herein, the term growth factor includes proteins from natural sources or from recombinant cell culture and biologically active equivalents of the native-sequence growth factor, including synthetically produced small-molecule entities and pharmaceutically acceptable derivatives and salts thereof.

As used herein, the term “molecular toxin” refers to a compound produced by an organism which causes or initiates the development of a noxious, poisonous or deleterious effect in a host presented with the toxin. Such deleterious conditions may include fever, nausea, diarrhea, weight loss, neurologic disorders, renal disorders, hemorrhage, and the like. Toxins include, but are not limited to, bacterial toxins, such as cholera toxin, heat-liable and heat-stable toxins of E. coli, toxins A and B of Clostridium difficile, aerolysins, and hemolysins; toxins produced by protozoa, such as Giardia; toxins produced by fungi. Molecular toxins can also include exotoxins, i.e., toxins secreted by an organism as an extracellular product, and enterotoxins, i.e., toxins present in the gut of an organism.

In some embodiments, the target species can include a biological cell selected from the group consisting of living or dead cells (prokaryotic and eukaryotic, including mammalian), viruses, bacteria, fungi, yeast, protozoan, microbes, and parasites. The biological cell can be a normal cell or a diseased cell, e.g., a cancer cell. Mammalian cells include, without limitation; primate, human and a cell from any animal of interest, including without limitation; mouse, hamster, rabbit, dog, cat, domestic animals, such as equine, bovine, murine, ovine, canine, and feline. In some embodiments, the cells can be derived from a human subject. In other embodiments, the cells are derived from a domesticated animal, e.g., a dog or a cat. Exemplary mammalian cells include, but are not limited to, stem cells, cancer cells, progenitor cells, immune cells, blood cells, fetal cells, and any combinations thereof. The cells can be derived from a wide variety of tissue types without limitation such as; hematopoietic, neural, mesenchymal, cutaneous, mucosal, stromal, muscle, spleen, reticuloendothelial, epithelial, endothelial, hepatic, kidney, gastrointestinal, pulmonary, cardiovascular, T-cells, and fetus. Stem cells, embryonic stem (ES) cells, ES-derived cells and stem cell progenitors are also included, including without limitation, hematopoietic, neural, stromal, muscle, cardiovascular, hepatic, pulmonary, and gastrointestinal stem cells. Yeast cells may also be used as cells in this invention. In some embodiments, the cells can be ex vivo or cultured cells, e.g. in vitro. For example, for ex vivo cells, cells can be obtained from a subject, where the subject is healthy and/or affected with a disease. While cells can be obtained from a fluid sample, e.g., a blood sample, cells can also be obtained, as a non-limiting example, by biopsy or other surgical means know to those skilled in the art.

Exemplary fungi and yeast include, but are not limited to, Cryptococcus neoformans, Candida albicans, Candida tropicalis, Candida stellatoidea, Candida glabrata, Candida krusei, Candida parapsilosis, Candida guilliermondii, Candida viswanathii, Candida lusitaniae, Rhodotorula mucilaginosa, Aspergillus fumigatus, Aspergillus flavus, Aspergillus clavatus, Cryptococcus neoformans, Cryptococcus laurentii, Cryptococcus albidus, Cryptococcus gattii, Histoplasma capsulatum, Pneumocystis jirovecii (or Pneumocystis carinii), Stachybotrys chartarum, and any combination thereof.

Exemplary bacteria include, but are not limited to: anthrax, campylobacter, cholera, diphtheria, enterotoxigenic E. coli, giardia, gonococcus, Helicobacter pylori, Hemophilus influenza B, Hemophilus influenza non-typable, meningococcus, pertussis, pneumococcus, salmonella, shigella, Streptococcus B, group A Streptococcus, tetanus, Vibrio cholerae, yersinia, Staphylococcus, Pseudomonas species, Clostridia species, Myocobacterium tuberculosis, Mycobacterium leprae, Listeria monocytogenes, Salmonella typhi, Shigella dysenteriae, Yersinia pestis, Brucella species, Legionella pneumophila, Rickettsiae, Chlamydia, Clostridium perfringens, Clostridium botulinum, Staphylococcus aureus, Treponema pallidum, Haemophilus influenzae, Treponema pallidum, Klebsiella pneumoniae, Pseudomonas aeruginosa, Cryptosporidium parvum, Streptococcus pneumoniae, Bordetella pertussis, Neisseria meningitides, and any combination thereof.

Exemplary parasites include, but are not limited to: Entamoeba histolytica; Plasmodium species, Leishmania species, Toxoplasmosis, Helminths, and any combination thereof.

Exemplary viruses include, but are not limited to, HIV-1, HIV-2, hepatitis viruses (Including hepatitis B and C), Ebola virus, West Nile virus, and herpes virus such as HSV-2, adenovirus, dengue serotypes 1 to 4, ebola, enterovirus, herpes simplex virus 1 or 2, influenza, Japanese equine encephalitis, Norwalk, papilloma virus, parvovirus B19, rubella, rubeola, vaccinia, varicella, Cytomegalovirus, Epstein-Barr virus, Human herpes virus 6, Human herpes virus 7, Human herpes virus 8, Variola virus, Vesicular stomatitis virus, Hepatitis A virus, Hepatitis B virus, Hepatitis C virus, Hepatitis D virus, Hepatitis E virus, poliovirus, Rhinovirus, Coronavirus, Influenza virus A, Influenza virus B, Measles virus, Polyomavirus, Human Papilomavirus, Respiratory syncytial virus, Adenovirus, Coxsackie virus, Dengue virus, Mumps virus, Rabies virus, Rous sarcoma virus, Yellow fever virus, Ebola virus, Marburg virus, Lassa fever virus, Eastern Equine Encephalitis virus, Japanese Encephalitis virus, St. Louis Encephalitis virus, Murray Valley fever virus, West Nile virus, Rift Valley fever virus, Rotavirus A, Rotavirus B, Rotavirus C, Sindbis virus, Human T-cell Leukemia virus type-1, Hantavirus, Rubella virus, Simian Immunodeficiency viruses, and any combination thereof.

Exemplary contaminants found in non-biological fluids can include, but are not limited to microorganisms (e.g., Cryptosporidium, Giardia lamblia, bacteria, Legionella, Coliforms, viruses, fungi), bromates, chlorites, haloactic acids, trihalomethanes, chloramines, chlorine, chlorine dioxide, antimony, arsenic, mercury (inorganic), nitrates, nitrites, selenium, thallium, Acrylamide, Alachlor, Atrazine, Benzene, Benzo(a)pyrene (PAHs), Carbofuran, Carbon, etrachloride, Chlordane, Chlorobenzene, 2,4-D, Dalapon, 1,2-Dibromo-3-chloropropane (DBCP), o-Dichlorobenzene, p-Dichlorobenzene, 1,2-Dichloroethane, 1,1-Dichloroethylene, cis-1,2-Dichloroethylene, trans-1,2-Dichloroethylene, Dichloromethane, 1,2-Dichloropropane, Di(2-ethylhexyl) adipate, Di(2-ethylhexyl) phthalate, Dinoseb, Dioxin (2,3,7,8-TCDD), Diquat, Endothall, Endrin, Epichlorohydrin, Ethylbenzene, Ethylene dibromide, Glyphosate, Heptachlor, Heptachlor epoxide, Hexachlorobenzene, Hexachlorocyclopentadiene, Lead, Lindane, Methoxychlor, Oxamyl (Vydate), Polychlorinated, biphenyls (PCBs), Pentachlorophenol, Picloram, Simazine, Styrene, Tetrachloroethylene, Toluene, Toxaphene, 2,4,5-TP (Silvex), 1,2,4-Trichlorobenzene, 1,1,1-Trichloroethane, 1,1,2-Trichloroethane, Trichloroethylene, Vinyl chloride, and Xylenes.

### A Fluid and Preparation Thereof a Fluid Source and a Fluid Destination

A fluid source is any source that provides a volume of fluid to be processed, while a fluid destination is a location to where the processed or cleansed fluid is transferred. For example, in some embodiments, a fluid source can be a blood vein in a subject, and the fluid destination can be a different blood vein in the same subject. The fluid source and/or fluid destination can be biological (e.g., a biological fluid from a subject, e.g., a mammalian subject such as human or domesticated pets), environmental (e.g., wastewater from a wastewater treatment plant), or industrial (e.g., pharmaceutical and/or food/beverage manufacturing and/or processing plants).

As used herein, the term “fluid” refers to any flowable material that comprises one or more target species. Without wishing to be bound by theory, the fluid can be liquid (e.g., aqueous or non-aqueous), supercritical fluid, gases, solutions, and suspensions.

In some embodiments, reciprocating devices, systems and/or method described herein can be employed in situ, e.g., the fluid is directly transferred from and/or to a mammalian subject. Thus, the fluid is generally untreated prior to entering the processing chamber described herein.

In some embodiments, the fluid to be introduced into the processing chamber can include pre-treated (or pre-processed) fluid (e.g., biological fluid). The term “biological fluid” as used herein refers to aqueous fluids of biological origin, including solutions, suspensions, dispersions, and gels, and thus can or cannot contain undissolved particulate matter. Exemplary biological fluid includes, but is not limited to, blood (including whole blood, plasma, cord blood and serum), lactation products (e.g., milk), amniotic fluids, sputum, saliva, urine, semen, cerebrospinal fluid, bronchial aspirate, perspiration, mucus, liquefied feces, fecal sample, synovial fluid, lymphatic fluid, tears, tracheal aspirate, and fractions thereof. In some embodiments, the biological fluid can be a whole blood sample or a fraction thereof. In some embodiments, the biological fluid sample can include a subject's tissue extract, e.g., a homogenized tissue extract.

In some embodiments, the biological fluid obtained from a subject, e.g., a mammalian subject such as a human subject or a domestic pet such as a cat or a dog, can contain cells from the subject. In other embodiments, the biological fluid sample can contain non-cellular biological material, such as non-cellular fractions of blood, saliva, or urine, that can be used to measure plasma/serum biomarker expression levels.

The biological fluid can be freshly collected from a subject or previously collected. In some embodiments, the biological fluid can be collected from a subject no more than 24 hours, no more than 12 hours, no more than 6 hours, no more than 3 hours, no more than 2 hours, no more than 1 hour, no more than 30 mins or shorter.

In some embodiments, the biological fluid can be whole blood from a blood bank. For example, the whole blood can be processed using a reciprocating fluid cleansing device, system and/or method described herein before transfusing it to a subject. In such embodiment, the fluid source can be whole blood in a blood bag, and the fluid destination can be a subject in need of blood transfusion.

In some embodiments, the biological fluid described herein can be treated with a chemical and/or biological reagent prior to use with the reciprocating devices, systems, and/or methods described herein. Examples of the chemical and/or biological reagents can include, without limitations, surfactants and detergents, salts, cell lysing reagents, anticoagulants, degradative enzymes (e.g., proteases, lipases, nucleases, collagenases, cellulases, amylases), and solvents such as buffer solutions.

The skilled artisan is well aware of methods and processes appropriate for pre-processing of the fluid or the biological fluid, e.g., blood, if any, required for separating one or more target species therefrom. For example, reagents and treatments for processing blood before assaying are well known in the art, e.g., as used for assays on Abbott TDx, AxSYM®, and ARCHITECT® analyzers (Abbott Laboratories), as described in the literature (see, e.g., Yatscoff et al., Abbott TDx Monoclonal Antibody Assay Evaluated for Measuring Cyclosporine in Whole Blood, Clin. Chem. 36: 1969-1973 (1990), and Wallemacq et al., Evaluation of the New AxSYM Cyclosporine Assay Comparison with TDx Monoclonal Whole Blood and EMIT Cyclosporine Assays, Clin. Chem. 45: 432-435 (1999)), and/or as commercially available. Additionally, pretreatment can be done as described in Abbott's U.S. Pat. No. 5,135,875, European Pat. Pub. No. 0 471 293, U.S. Provisional Pat. App. 60/878,017, filed Dec. 29, 2006, and U.S. Pat. App. Pub. No. 2008/0020401, content of all of which is incorporated herein by reference in its entirety. It is to be understood that one or more of these known reagents and/or treatments can be used in addition to or alternatively to the sample treatment described herein.

Other than biological fluid obtained from a subject, such as a mammalian subject, e.g., a human subject and/or a domesticated pet, e.g., a cat or a dog, additional examples of biological fluid can include cell culture fluids, including those obtained by culturing or fermentation, for example, of single- or multi-cell organisms, including prokaryotes (e.g., bacteria) and eukaryotes (e.g., animal cells, plant cells, yeasts, fungi), and including fractions thereof. In some embodiments, the cell culture fluids can include culture media and/or reagents comprising biological products (e.g., proteins secreted by cells cultured therein). As used herein, the term “media” refers to a medium for maintaining a tissue or cell population, or culturing a cell population (e.g. “culture media”) containing nutrients that maintain cell viability and support proliferation. The cell culture medium can contain any of the following in an appropriate combination: salt(s), buffer(s), amino acids, glucose or other sugar(s), antibiotics, serum or serum replacement, and other components such as peptide growth factors, etc. Cell culture media ordinarily used for particular cell types are known to those skilled in the art. The media can include media to which cells have been already been added, i.e., media obtained from ongoing cell culture experiments, or in other embodiments, be media prior to the addition of cells.

As used herein, the term “reagent” refers to any solution used in a laboratory or clinical setting for biomedical and molecular biology applications. Reagents include, but are not limited to, saline solutions, PBS solutions, buffer solutions, such as phosphate buffers, EDTA, Tris solutions, and the like. Reagent solutions can be used to create other reagent solutions. For example, Tris solutions and EDTA solutions are combined in specific ratios to create “TE” reagents for use in molecular biology applications.

Yet another example of biological fluids can include cell lysate fluids and fractions thereof. For example, cells (such as red blood cells, white blood cells, circulating cells, cultured cells) can be harvested and lysed to obtain a cell lysate (e.g., a biological fluid), from which molecules of interest (e.g., hemoglobin, interferon, T-cell growth factor, interleukins) can be separated with the aid of some aspects of the present invention.

Without wishing to be bound, in some embodiments, the fluid sample to be used with the reciprocating devices, systems, and/or methods described herein can be a non-biological fluid. As used herein, the term “non-biological fluid” refers to any aqueous, non-aqueous or gaseous sample that is not a biological fluid as the term is defined herein. Exemplary non-biological fluids include, but are not limited to, water, wastewater, salt water, brine, organic solvents such as alcohols (e.g., methanol, ethanol, isopropyl alcohol, and butanol), saline solutions, sugar solutions, carbohydrate solutions, lipid solutions, nucleic acid solutions, hydrocarbons (e.g. liquid hydrocarbons), acids, gasolines, petroleum, liquefied samples (e.g., liquefied foods), gases (e.g., oxygen, CO2, air, nitrogen, or an inert gas), and mixtures thereof, and any fluids that can be found in environments (e.g., wastewater, sewage) and processing plants for pharmaceutical, food or beverage products.

### Species-Targeting Magnetic Particles

As used herein, the term “species-targeting magnetic particles” refers to magnetic particles conjugated to species-targeting molecules. In some embodiments, the term “species-targeting magnetic particles” refers to magnetic particles that adapted to be capable of binding or capturing at least one target species to be removed from the fluid.

By “species-targeting molecules” is meant herein molecules that can interact with or bind to a target species or a target analyte such that the target species or target analyte can be captured, isolated or removed from a fluid. Typically the nature of the interaction or binding is noncovalent, e.g., by hydrogen, electrostatic, or van der Waals interactions, however, binding can also be covalent. Species-targeting molecules can be naturally-occurring, recombinant or synthetic. Examples of the species-targeting molecule can include, but are not limited to, a nucleic acid, an antibody or a portion thereof, an antibody-like molecule, an enzyme, an antigen, a small molecule, a protein, a peptide, a peptidomimetic, a carbohydrate, an aptamer, and any combinations thereof. By way of example only, to form an immunomagnetic particle, the species-targeting molecule can be an antibody specific to the target antigen to be captured. An ordinary artisan can readily identify appropriate species-targeting molecules for each target species of interest to be removed from a fluid.

In some embodiments, the species-targeting molecules can be modified by any means known to one of ordinary skill in the art. Methods to modify each type of species-targeting molecules are well recognized in the art. Depending on the types of species-targeting molecules, an exemplary modification includes, but is not limited to genetic modification, biotinylation, labeling (for detection purposes), chemical modification (e.g., to produce derivatives or fragments of the species-targeting molecule), and any combinations thereof. In some embodiments, the species-targeting molecule can be genetically modified. In some embodiments, the species-targeting molecule can be biotinylated.

As used herein, the terms “proteins” and “peptides” are used interchangeably herein to designate a series of amino acid residues connected to the other by peptide bonds between the alpha-amino and carboxy groups of adjacent residues. The terms “protein”, and “peptide”, which are used interchangeably herein, refer to a polymer of protein amino acids, including modified amino acids (e.g., phosphorylated, glycated, etc.) and amino acid analogs, regardless of its size or function. Although “protein” is often used in reference to relatively large polypeptides, and “peptide” is often used in reference to small polypeptides, usage of these terms in the art overlaps and varies. The term “peptide” as used herein refers to peptides, polypeptides, proteins and fragments of proteins, unless otherwise noted. The terms “protein” and “peptide” are used interchangeably herein when referring to a gene product and fragments thereof. Thus, exemplary peptides or proteins include gene products, naturally occurring proteins, homologs, orthologs, paralogs, fragments and other equivalents, variants, fragments, and analogs of the foregoing.

As used herein, the term “peptidomimetic” refers to a molecule capable of folding into a defined three-dimensional structure similar to a natural peptide.

The term “nucleic acids” used herein refers to polymers (polynucleotides) or oligomers (oligonucleotides) of nucleotide or nucleoside monomers consisting of naturally occurring bases, sugars and intersugar linkages. The term “nucleic acid” also includes polymers or oligomers comprising non-naturally occurring monomers, or portions thereof, which function similarly. Exemplary nucleic acids include, but are not limited to, deoxyribonucleic acid (DNA), ribonucleic acid (RNA), locked nucleic acid (LNA), peptide nucleic acids (PNA), and polymers thereof in either single- or double-stranded form. Locked nucleic acid (LNA), often referred to as inaccessible RNA, is a modified RNA nucleotide. The ribose moiety of an LNA nucleotide is modified with an extra bridge connecting the 2′ oxygen and 4′ carbon. The bridge “locks” the ribose in the 3′-endo conformation. LNA nucleotides can be mixed with DNA or RNA residues in the oligonucleotide whenever desired. Such LNA oligomers are generally synthesized chemically. Peptide nucleic acid (PNA) is an artificially synthesized polymer similar to DNA or RNA. DNA and RNA have a deoxyribose and ribose sugar backbone, respectively, whereas PNA's backbone is composed of repeating N-(2-aminoethyl)-glycine units linked by peptide bonds. PNA is generally synthesized chemically. Unless specifically limited, the term “nucleic acids” encompasses nucleic acids containing known analogs of natural nucleotides, which have similar binding properties as the reference nucleic acid and are metabolized in a manner similar to naturally occurring nucleotides. Unless otherwise indicated, a particular nucleic acid sequence also implicitly encompasses conservatively modified variants thereof (e.g., degenerate codon substitutions) and complementary sequences, as well as the sequence explicitly indicated. Specifically, degenerate codon substitutions may be achieved by generating sequences in which the third position of one or more selected (or all) codons is substituted with mixed-base and/or deoxyinosine residues (Batzer, et al., Nucleic Acid Res. 19:5081 (1991); Ohtsuka, et al., J. Biol. Chem. 260:2605-2608 (1985), and Rossolini, et al., Mol. Cell. Probes 8:91-98 (1994)). The term “nucleic acid” should also be understood to include, as equivalents, derivatives, variants and analogs of either RNA or DNA made from nucleotide analogs, and, single (sense or antisense) and double-stranded polynucleotides.

The term “enzymes” as used here refers to a protein molecule that catalyzes chemical reactions of other substances without it being destroyed or substantially altered upon completion of the reactions. The term can include naturally occurring enzymes and bioengineered enzymes or mixtures thereof. Examples of enzyme families include kinases, dehydrogenases, oxidoreductases, GTPases, carboxyl transferases, acyl transferases, decarboxylases, transaminases, racemases, methyl transferases, formyl transferases, and α-ketodecarboxylases.

The term “carbohydrate” is used herein in reference to a carbohydrate-based ligand having an affinity for a given cell receptor, such as a carbohydrate-binding protein or an enzyme, and is composed solely or partially of carbohydrate or sugar moieties. In some embodiments, a carbohydrate ligand can be specific for MHC molecules. In some embodiments, a carbohydrate ligand can be specific for a microbe (e.g., virus or bacteria).

As used herein, the term “aptamers” means a single-stranded, partially single-stranded, partially double-stranded or double-stranded nucleotide sequence capable of specifically recognizing a selected non-oligonucleotide molecule or group of molecules. In some embodiments, the aptamer recognizes the non-oligonucleotide molecule or group of molecules by a mechanism other than Watson-Crick base pairing or triplex formation. Aptamers can include, without limitation, defined sequence segments and sequences comprising nucleotides, ribonucleotides, deoxyribonucleotides, nucleotide analogs, modified nucleotides and nucleotides comprising backbone modifications, branchpoints and normucleotide residues, groups or bridges. Methods for selecting aptamers for binding to a molecule are widely known in the art and easily accessible to one of ordinary skill in the art.

As used herein, the term “exosome” generally refers to externally released vesicles originating from the endosomic compartment or any cells, e.g., tumor cells (e.g., prostate cancer cells), and immune cells (e.g., antigen presenting cells, such as dendritic cells, macrophages, mast cells, T lymphocytes or B lymphocytes). Exosomes are generally membrane vesicles with a size of about 20-100 nm that are released from a variety of different cell types including tumor cells, red blood cells, platelets, lymphocytes, and dendritric cells. Exosomes can be formed by invagination and budding from the membrane of late endosomes. They can accumulate in cytosolic multivesicular bodies (MVBs) from where they can be released by fusion with the plasma membrane. Without wishing to be bound by theory, the process of vesicle shedding is particularly active in proliferating cells, such as cancer cells, where the release can occur continuously. When released from tumor cells, exosomes can promote invasion and migration. Thus, in some embodiments, the species-targeting magnetic particles described herein can be used to target exosomes originated from cancer cells, e.g., for diagnosis and/or prognosis. Depending on the cellular origin, exosomes can recruit various cellular proteins that can be different from the plasma membrane including MHC molecules, tetraspanins, adhesion molecules and metalloproteinases. Exosomes can be present in various body fluids including, but not limited to, blood plasma, malignant ascites and urine.

As used herein, the term “antibody” or “antibodies” refers to an intact immunoglobulin or to a monoclonal or polyclonal antigen-binding fragment with the Fc (crystallizable fragment) region or FcRn binding fragment of the Fc region. The term “antibodies” also includes “antibody-like molecules”, such as fragments of the antibodies, e.g., antigen-binding fragments. Antigen-binding fragments can be produced by recombinant DNA techniques or by enzymatic or chemical cleavage of intact antibodies. “Antigen-binding fragments” include, inter alia, Fab, Fab′, F(ab′)2, Fv, dAb, and complementarity determining region (CDR) fragments, single-chain antibodies (scFv), single domain antibodies, chimeric antibodies, diabodies, and polypeptides that contain at least a portion of an immunoglobulin that is sufficient to confer specific antigen binding to the polypeptide. Linear antibodies are also included for the purposes described herein. The terms Fab, Fc, pFc′, F(ab′)2 and Fv are employed with standard immunological meanings (Klein, Immunology (John Wiley, New York, N.Y., 1982); Clark, W. R. (1986) The Experimental Foundations of Modern Immunology (Wiley & Sons, Inc., New York); and Roitt, I. (1991) Essential Immunology, 7th Ed., (Blackwell Scientific Publications, Oxford)). Antibodies or antigen-binding fragments specific for various antigens are available commercially from vendors such as R&D Systems, BD Biosciences, e-Biosciences and Miltenyi, or can be raised against these cell-surface markers by methods known to those skilled in the art.

As used herein, the term “Complementarity Determining Regions” (CDRs; i.e., CDR1, CDR2, and CDR3) refers to the amino acid residues of an antibody variable domain the presence of which are necessary for antigen binding. Each variable domain typically has three CDR regions identified as CDR1, CDR2 and CDR3. Each complementarity determining region may comprise amino acid residues from a “complementarity determining region” as defined by Kabat (i.e., about residues 24-34 (L1), 50-56 (L2) and 89-97 (L3) in the light chain variable domain and 31-35 (H1), 50-65 (H2) and 95-102 (H3) in the heavy chain variable domain; Kabat et al., Sequences of Proteins of Immunological Interest, 5th Ed. Public Health Service, National Institutes of Health, Bethesda, Md. (1991)) and/or those residues from a “hypervariable loop” (i.e. about residues 26-32 (L1), 50-52 (L2) and 91-96 (L3) in the light chain variable domain and 26-32 (H1), 53-55 (H2) and 96-101 (H3) in the heavy chain variable domain; Chothia and Lesk J. Mol. Biol. 196:901-917 (1987)). In some instances, a complementarity determining region can include amino acids from both a CDR region defined according to Kabat and a hypervariable loop.

The expression “linear antibodies” refers to the antibodies described in Zapata et al., Protein Eng., 8(10):1057-1062 (1995). Briefly, these antibodies comprise a pair of tandem Fd segments (VH—CH1-VH—CH1) which, together with complementary light chain polypeptides, form a pair of antigen binding regions. Linear antibodies can be bispecific or monospecific.

The expression “single-chain Fv” or “scFv” antibody fragments, as used herein, is intended to mean antibody fragments that comprise the VH and VL domains of antibody, wherein these domains are present in a single polypeptide chain. Preferably, the Fv polypeptide further comprises a polypeptide linker between the VH and VL domains which enables the scFv to form the desired structure for antigen binding. (The Pharmacology of Monoclonal Antibodies, vol. 113, Rosenburg and Moore eds., Springer-Verlag, New York, pp. 269-315 (1994)).

The term “diabodies,” as used herein, refers to small antibody fragments with two antigen-binding sites, which fragments comprise a heavy-chain variable domain (VH) Connected to a light-chain variable domain (VL) in the same polypeptide chain (VH-VL). By using a linker that is too short to allow pairing between the two domains on the same chain, the domains are forced to pair with the complementary domains of another chain and create two antigen-binding sites. (EP 404,097; WO 93/11161; Hollinger et ah, Proc. Natl. Acad. Sd. USA, P0:6444-6448 (1993)).

As used herein, the term “small molecules” refers to natural or synthetic molecules including, but not limited to, peptides, peptidomimetics, amino acids, amino acid analogs, polynucleotides, polynucleotide analogs, aptamers, nucleotides, nucleotide analogs, organic or inorganic compounds (I.e., including heteroorganic and organometallic compounds) having a molecular weight less than about 10,000 grams per mole, organic or inorganic compounds having a molecular weight less than about 5,000 grams per mole, organic or inorganic compounds having a molecular weight less than about 1,000 grams per mole, organic or inorganic compounds having a molecular weight less than about 500 grams per mole, and salts, esters, and other pharmaceutically acceptable forms of such compounds.

As used herein, the term “antigens” refers to a molecule or a portion of a molecule capable of being bound by a selective binding agent, such as an antibody, and additionally capable of being used in an animal to elicit the production of antibodies capable of binding to an epitope of that antigen. An antigen may have one or more epitopes. The term “antigen” can also refer to a molecule capable of being bound by an antibody or a T cell receptor (TCR) if presented by MHC molecules. The term “antigen”, as used herein, also encompasses T-cell epitopes. An antigen is additionally capable of being recognized by the immune system and/or being capable of inducing a humoral immune response and/or cellular immune response leading to the activation of B- and/or T-lymphocytes. This may, however, require that, at least in certain cases, the antigen contains or is linked to a Th cell epitope and is given in adjuvant. An antigen can have one or more epitopes (B- and T-epitopes). The specific reaction referred to above is meant to indicate that the antigen will preferably react, typically in a highly selective manner, with its corresponding antibody or TCR and not with the multitude of other antibodies or TCRs which may be evoked by other antigens. Antigens as used herein may also be mixtures of several individual antigens.

In some embodiments, the species-targeting molecule can be an antibody or a portion thereof, or an antibody-like molecule. In some embodiments, the species-targeting molecule can be an antibody or a portion thereof, or an antibody-like molecule that is specific for detection of a target species described herein.

In some embodiments, the species-targeting molecule can be a nucleic acid or a modified nucleic acid (e.g., DNA, RNA, LNA, PNA, modified RNA, or any combinations thereof). For example, the nucleic acid can encode the gene specific for a cell or a microbe to be removed.

In some embodiments, the species-targeting molecule can be a protein or a peptide. In some embodiments, the protein or peptide can be essentially any proteins that can bind to a cell or microbe.

In some embodiments, the species-targeting molecule can be an aptamer. In some embodiments, the species-targeting molecule can be a DNA or RNA aptamer. For example, the DNA or RNA aptamer can encode a nucleic acid sequence corresponding to a cell or a microbe biomarker or a fraction thereof, for use as a species-targeting molecule on the magnetic particles described herein.

In some embodiments, the species-targeting molecule can be a cell surface receptor ligand. As used herein, a “cell surface receptor ligand” refers to a molecule that can bind to the outer surface of a cell. Exemplary, cell surface receptor ligand includes, for example, a cell surface receptor binding peptide, a cell surface receptor binding glycopeptide, a cell surface receptor binding protein, a cell surface receptor binding glycoprotein, a cell surface receptor binding organic compound, and a cell surface receptor binding drug. Additional cell surface receptor ligands include, but are not limited to, cytokines, growth factors, hormones, antibodies, and angiogenic factors. In some embodiments, any art-recognized cell surface receptor ligand that can bind to a cell or microbe can be used as a species-targeting molecule on the magnetic particles described herein.

In some embodiments, the species-targeting magnetic particles are magnetic particles coated with engineered mannose-binding lectin (MBL) molecules, e.g., as described in U.S. Pat. App. Pub. No. US 2013/0035283 and International Pat. App. Pub. No. WO 2013/012924, the contents of which are incorporated herein by reference. In some embodiments, the species-targeting magnetic particles are magnetic particles coated with at least a fraction of a mannose-binding lectin. In some embodiments, MBL-coated magnetic particles can be at least partially coated with heparin molecules, e.g., to reduce clumping of the MBL-coated magnetic particles in blood.

### Magnetic Particles

The magnetic particles can be of any shape, including but not limited to spherical, rod, elliptical, cylindrical, and disc. In some embodiments, magnetic particles having a substantially spherical shape and defined surface chemistry can be used to minimize chemical agglutination and non-specific binding. As used herein, the term “magnetic particles” can refer to a nano- or micro-scale particle that is attracted or repelled by a magnetic field gradient or has a non-zero magnetic susceptibility. The magnetic particles can be ferromagnetic, paramagnetic or super-paramagnetic. In some embodiments, magnetic particles can be super-paramagnetic. In some embodiments, magnetic particles can have a polymer shell for protecting the species-targeting molecules from exposure to iron provided that the polymer shell has no adverse effect on the magnetic property and/or a fluid sample. For example, the magnetic particles can be coated with a biocompatible polymer.

The magnetic particles can range in size from 1 nm to 1 mm. For example, magnetic particles can be about 50 nm to about 250 μm in size. In some embodiments, magnetic particles can be about 0.05 μm to about 100 μm in size. In some embodiments, magnetic particles can be about 0.05 μm to about 10 μm in size. In some embodiments, magnetic particles can be about 0.05 μm to about 5 μm in size. In some embodiments, magnetic particles can be about 0.1 μm to about 5 μm in size. Magnetic particles are a class of particles which can be manipulated using magnetic field and/or magnetic field gradient. Such particles commonly consist of magnetic elements such as iron, nickel and cobalt and their oxide compounds. Magnetic particles (including nanoparticles or microparticles) are well-known and methods for their preparation have been described in the art. See, e.g., U.S. Pat. No. 6,878,445; No. 5,543,158; No. 5,578,325; No. 6,676,729; No. 6,045,925; and No. 7,462,446; and U.S. Patent Publications No. 2005/0025971; No. 2005/0200438; No. 2005/0201941; No. 2005/0271745; No. 2006/0228551; No. 2006/0233712; No. 2007/01666232; and No. 2007/0264199.

Magnetic particles are also widely and commercially available. In some embodiments, the magnetic particle can be functionalized with an organic moiety or functional group that can connect the magnetic particle to one or a plurality of the species-targeting molecules. Such organic moiety or functional groups can typically comprise a direct bond or an atom such as oxygen or sulfur, a unit such as NH, C(O), C(O)NH, SO, SO2, SO2NH, SS, or a chain of atoms, such as substituted or unsubstituted C1-C6 alkyl, substituted or unsubstituted C2-C6 alkenyl, substituted or unsubstituted C2-C6 alkynyl, substituted or unsubstituted C6-C12 aryl, substituted or unsubstituted C5-C12 heteroaryl, substituted or unsubstituted C5-C12 heterocyclyl, substituted or unsubstituted C3-C12 cycloalkyl, where one or more methylenes can be interrupted or terminated by O, S, S(O), SO2, NH, C(O).

In some embodiments, the organic moiety or functional group can be a branched moiety or functional group, which contains a branchpoint available for multiple valencies. Examples of branchpoint can include, but not limited to, —N, —N(R)—C, —O—C, —S—C, —SS—C, —C(O)N(R)—C, —OC(O)N(R)—C, —N(R)C(O)—C, or —N(R)C(O)O—C; wherein R is independently for each occurrence H or optionally substituted alkyl. In some embodiments, the branchpoint is glycerol or derivative thereof.

In certain embodiments, the organic moiety or functional groups can be surface functional groups capable of direct coupling of the magnetic particles to species-targeting molecules of a user's choice. For example, in some embodiments, the magnetic particles can be functionalized with various surface functional groups, e.g., amino groups, carboxylic acid groups, epoxy groups, tosyl groups, or silica-like groups. Suitable magnetic particles are commercially available such as from PerSeptive Diagnostics, Inc. (Cambridge, Mass.); Invitrogen Corp. (Carlsbad, Calif.); Cortex Biochem Inc. (San Leandro, Calif.); and Bangs Laboratories (Fishers, Ind.). In particular embodiments, magnetic particles that can be used herein can be any DYNABEADS® magnetic particles (Invitrogen Inc.), depending on the substrate surface chemistry.

In some embodiments, the magnetic particles can be coated with one member of an affinity binding pair that can facilitate the conjugation of the magnetic particles to species-targeting molecules. The term “affinity binding pair” or “binding pair” refers to first and second molecules that specifically bind to each other. One member of the binding pair is conjugated with first part to be linked while the second member is conjugated with the second part to be linked. As used herein, the term “specific binding” refers to binding of the first member of the binding pair to the second member of the binding pair with greater affinity and specificity than to other molecules.

Exemplary binding pairs include any haptenic or antigenic compound in combination with a corresponding antibody or binding portion or fragment thereof (e.g., digoxigenin and anti-digoxigenin; mouse immunoglobulin and goat antimouse immunoglobulin) and nonimmunological binding pairs (e.g., biotin-avidin, biotin-streptavidin, biotin-neutravidin, hormone [e.g., thyroxine and cortisol-hormone binding protein, receptor-receptor agonist, receptor-receptor antagonist (e.g., acetylcholine receptor-acetylcholine or an analog thereof), IgG-protein A, IgG-protein G, IgG-synthesized protein AG, lectin-carbohydrate, enzyme-enzyme cofactor, enzyme-enzyme inhibitor, and complementary oligonucleotide pairs capable of forming nucleic acid duplexes), and the like. The binding pair can also include a first molecule which is negatively charged and a second molecule which is positively charged.

One example of using binding pair conjugation is the biotin-avidin, biotin-streptavidin or biotin-neutravidin conjugation. Accordingly, in some embodiments, the magnetic particles can be coated with avidin-like molecules (e.g., streptavidin or neutravidin), which can be conjugated to biotinylated species-targeting molecules.

Another example of using binding pair conjugation is the biotin-sandwich method. See, e.g., example Davis et al., Proc. Natl. Acad. Sci. USA, 103: 8155-60 (2006). The two molecules to be conjugated together are biotinylated and then conjugated together using at least one tetravalent avidin-like molecule (e.g., avidin, streptavidin, or neutravidin) as a linker. In such embodiments, both magnetic particles and the species-targeting molecules can be biotinylated and then linked together using an avidin-like molecule (e.g., avidin, streptavidin, or neutravidin).

In some embodiments, the magnetic particles can be coated with a secondary antibody, which can be conjugated to a primary antibody. The term “primary antibody” as used herein refers to an antibody against an antigen. A primary antibody can be a monoclonal antibody, a polyclonal antibody, or a fraction thereof. A primary antibody can be labeled with a detection molecule or unlabeled. The term “secondary antibody” as used herein refers to an anti-immunoglobulin antibody, i.e., an antibody against an immunoglobulin (for example, IgG) of a specific organism which has produced the antigen-specific antibody (e.g., primary antibody).

In some embodiments, the magnetic particles can further comprise one or more nucleic acid labels. In some embodiments, one or more nucleic acid labels can be conjugated to a magnetic particle and/or the species-targeting molecule. For example, at least 1, at least 2, at least 3, at least 4, at least 5, at least 6, at least 7, at least 8, at least 9, at least 10 or more nucleic acid labels can be conjugated to a magnetic particle and/or the species-targeting molecule. The term “nucleic acid label” as used herein refers to a unique nucleic acid sequence that can be used to identify each kind of the species-targeting magnetic particles. Thus, a mixture of different kinds of species-targeting magnetic particles can be used simultaneously to capture more than one target species, e.g., at least 2, at least 3, at least 4, at least 5 or more target species, in a single fluid sample introduced into the reciprocating fluid cleansing device and/or system described herein, and a plurality of target species can then be identified subsequently in accordance with the nucleic acid label conjugated to the magnetic particles to which each target species binds. Such capability enables the reciprocating fluid cleansing devices, systems, and/or methods described herein to be used for multiplexed analyte detection and/or high throughput analysis.

The nucleic acid label can have a sequence of any length. For example, the nucleic acid label can have a sequence length ranging from about 2 nucleotides to about 100 nucleotides, ranging from about 3 nucleotides to about 75 nucleotides, or ranging from about 4 nucleotides to about 50 nucleotides. The nucleotide sequence should be designed to minimize cross-hybridization.

Embodiments of Various Aspects Described Herein can be Defined in any of the Following Numbered Paragraphs:
1. A system for removing a target species from a fluid source comprising:
   i. a reciprocating fluid cleansing device, comprising:
      (i) a first processing chamber including a port at a first end for fluid passage and a first movable plunger disposed at a second end, wherein the first movable plunger is configured to be in contact with a fluid and includes a motorized mixing element for mixing the fluid with species-targeting magnetic particles; and wherein motion of the first movable plunger in a first direction is configured to transfer a first volume of the fluid from the fluid source into the first processing chamber; and motion of the first movable plunger in a second direction is configured to transfer the first volume of the fluid from the first processing chamber to a fluid destination; and
      (ii) at least one magnetic element for providing a magnetic field gradient within the first processing chamber, and
   ii. a first connector configured to connect the port of the first processing chamber to the fluid source and the fluid destination.
2. The system of paragraph 1, wherein the reciprocating fluid cleansing device further comprises:
   (i) a second processing chamber, wherein the second processing chamber includes a port at a first end for fluid passage and a second movable plunger disposed at a second end, wherein the second movable plunger is mechanically coupled to the first movable plunger such that the motion of the first movable plunger in the first direction transfers the first volume of the fluid from the fluid source into the first processing chamber and simultaneously transfers a second volume of a fluid from the second processing chamber to the fluid destination; and the motion of the first movable plunger in the second direction transfers the first volume of the fluid from the first processing chamber to the fluid destination and simultaneously transfers a third volume of the fluid from the fluid source into the second processing chamber; and
   (ii) at least one magnetic element for providing a magnetic field gradient within the second processing chamber.
3. The system of paragraph 2, further comprising a second connector connecting the port of the second processing chamber to the fluid source and the fluid destination.
4. The system of paragraph 2 or 3, wherein the second movable plunger in contact with a fluid includes a motorized mixing element for mixing the fluid with species-targeting magnetic particles.
5. The system of any of paragraphs 1-4, wherein the species-targeting magnetic particles are magnetic particles that are adapted to be capable of binding or capturing the target species to be removed from the fluid.
6. The system of any of paragraphs 1-5, wherein the magnetic field gradient within the processing chamber is adjustable.
7. The system of any of paragraphs 1-6, further comprising at least one detection module for detecting the target species in the fluid transferred from the fluid source or to the fluid destination.
8. The system of any of paragraphs 1-7, wherein at least one of the first processing chamber, and the second processing chamber is pre-loaded with a plurality of the species-targeting magnetic particles.
9. The system of any of paragraphs 1-8, further comprising a supply chamber periodically supplying the fluid from the fluid source, prior to entering the first or the second processing chamber, with a plurality of fresh species-targeting magnetic particles.
10. The system of paragraph 9, wherein the detection module sends a signal to the supply chamber to release specific species-targeting magnetic particles.
11. The system of any of paragraphs 1-10, wherein the species-targeting magnetic particles comprise at least a fraction of mannose-binding lectin (MBL).
12. The system of any of paragraphs 1-11, wherein said at least one magnetic element is disposed in at least one of the first processing chamber and the second processing chamber.
13. The system of paragraph 12, wherein said at least one magnetic element is integrated with the motorized mixing element.
14. The system of paragraph 13, wherein the motorized mixing element becomes capable of providing the magnetic field gradient within at least one of the first processing chamber and the second chamber.
15. The system of paragraph 12, wherein said at least one magnetic element is adapted to be capable of moving in and out of at least one of the first processing chamber and the second processing chamber.
16. The system of any of paragraphs 1-15, wherein said at least one magnetic element is placed around an exterior surface of at least one of the first processing chamber and the second processing chamber.
17. The system of any of paragraphs 1-16, wherein said at least one magnetic element is selected from a group consisting of a permanent magnet, an electromagnet, a magnetizable material, and any combinations thereof.
18. The system of any of paragraphs 1-17, wherein the motorized mixing element comprises an impeller.
19. The system of paragraph 18, wherein the impeller is configured for low-shear mixing.
20. The system of any of paragraphs 1-19, wherein the motorized mixing element comprises a flexible strip of a fluid-compatible material that extends and collapses freely to mix along the length of the processing chamber.
21. The system of any of paragraphs 1-20, wherein at least one the first movable plunger and the second movable plunger further comprises a tachometer wheel, a switch, a potentiometer speed dial, a battery or any combinations thereof.
22. The system of any of paragraphs 1-21, further comprising at least one catheter connecting the port to the fluid source and the fluid destination.
23. The system of any of paragraphs 1-22, further comprising a mixer device adapted to connect between the fluid source and the first or the second processing chamber.
24. The system of paragraph 23, wherein the mixer device includes a spiral mixer.
25. A reciprocating fluid cleansing device for removing a target species from a fluid source, comprising:
   i. a first processing chamber including a port at a first end for fluid passage and a first movable plunger disposed at a second end, wherein the first movable plunger is configured to be in contact with a fluid and includes a motorized mixing element for mixing the fluid with species-targeting magnetic particles; and wherein motion of the first movable plunger in a first direction is configured to transfer a first volume of the fluid from the fluid source into the first processing chamber; and motion of the first movable plunger in a second direction is configured to transfer the first volume of the fluid from the first processing chamber to a fluid destination; and
   ii. at least one magnetic element for providing a magnetic field gradient within the first processing chamber.
26. The reciprocating device of paragraph 25, further comprising:
   (i) a second processing chamber, wherein the second processing chamber includes a port at a first end for fluid passage and a second movable plunger disposed at a second end, and wherein the second movable plunger is mechanically coupled to the first movable plunger such that the motion of the first movable plunger in the first direction transfers the first volume of the fluid from the fluid source into the first processing chamber and simultaneously transfers a second volume of a fluid from the second processing chamber to the fluid destination; and the motion of the first movable plunger in the second direction transfers the first volume of the fluid from the first processing chamber to the fluid destination and simultaneously transfers a third volume of the fluid from the fluid source into the second processing chamber; and
   (ii) at least one magnetic element for providing a magnetic field gradient within the second processing chamber.
27. The reciprocating device of paragraph 25 or 26, wherein the second movable plunger in contact with a fluid includes a motorized mixing element for mixing the fluid with species-targeting magnetic particles.
28. The reciprocating device of any of paragraphs 25-27, wherein the magnetic field gradient within the processing chamber is adjustable.
29. The reciprocating device of any of paragraphs 25-28, wherein said at least one magnetic element is disposed in at least one of the first processing chamber and the second processing chamber.
30. The reciprocating device of paragraph 29, wherein said at least one magnetic element is integrated with the motorized mixing element.
31. The reciprocating device of paragraph 30, wherein the motorized mixing element becomes capable of providing the magnetic field gradient within at least one of the first processing chamber and the second chamber.
32. The reciprocating device of paragraph 29, wherein said at least one magnetic element is adapted to be capable of moving in and out of at least one of the first processing chamber and the second processing chamber.
33. The reciprocating device of any of paragraphs 25-30, wherein said at least one magnetic element is placed around an exterior surface of at least one of the first processing chamber and the second processing chamber.
34. The reciprocating device of any of paragraphs 25-33, wherein said at least one magnetic element is selected from a group consisting of a permanent magnet, an electromagnet, a magnetizable material, and any combinations thereof.
35. The reciprocating device of any of paragraphs 25-34, wherein the motorized mixing element comprises an impeller.
36. The reciprocating device of paragraph 35, wherein the impeller is configured for low-shear mixing.
37. The reciprocating device of any of paragraphs 25-34, wherein the motorized mixing element comprises a flexible strip of a fluid-compatible material that extends and collapses freely to mix along the length of the chamber.
38. The reciprocating device of any of paragraphs 25-37, wherein at least one of the first movable plunger and the second movable plunger further comprises a tachometer wheel, a switch, a potentiometer speed dial, a battery or any combinations thereof
39. The reciprocating device of any of paragraphs 25-38, further comprising at least one catheter connected to the port of at least one of the first processing chamber and the second processing chamber.
40. The reciprocating device of any of paragraphs 25-39, wherein at least one of the first processing chamber and the second processing chamber further comprises a plurality of the species-targeting magnetic particles.
41. The reciprocating device of any of paragraphs 25-40, wherein the species-targeting magnetic particles comprise at least a fraction of MBL.
42. A method for removing a target species from a fluid source, comprising:
   i. providing a system of any of paragraphs 1-24 or a reciprocating device of any of paragraphs 25-41;
   ii. transferring, in the absence of a first magnetic field gradient, a first volume of a fluid from the fluid source into the first processing chamber;
   iii. activating the motorized mixing element of the first processing chamber to mix the first volume of the fluid loaded in the first processing chamber with a first plurality of species-targeting magnetic particles, wherein at least a portion of the first plurality of the species targeting magnetic particles bind to the target species present in the first volume of the fluid;
   iv. activating the magnetic element of the first processing chamber to generate the first magnetic field gradient for separating the first plurality of the species-targeting magnetic particles from the first volume of the fluid to yield a first magnetic particle-free fluid; and
   v. transferring, in the presence of the first magnetic field gradient, the first magnetic particle-free fluid to the fluid destination; thereby removing the target species from the first volume of the fluid.
43. The method of paragraph 42, further comprising activating the motorized mixing element of the second processing chamber to mix the second volume of the fluid loaded in the second processing chamber with a second plurality of species-targeting magnetic particles, wherein at least a portion of the second plurality of the species-targeting magnetic particles bind to the target species present in the second volume of the fluid; and further comprising activating the magnetic element of the second processing chamber to generate a second magnetic field gradient for separating the second plurality of the species-targeting magnetic particles from the second volume of the fluid to yield a second magnetic particle-free fluid, thereby removing the target species from the second volume of the fluid.
44. The method of paragraph 42 or 43, further comprising adding the first plurality of the species-targeting magnetic particles to the first volume of the fluid, prior to the first volume of the fluid entering the first processing chamber.
45. The method of any of paragraphs 42-44, further comprising adding the plurality of the species-targeting magnetic particles to the second volume of the fluid, prior to the second volume of the fluid entering the second processing chamber.
46. The method of any of paragraphs 42-45, wherein the fluid source is a blood vein of a subject.
47. The method of any of paragraphs 42-46, wherein the fluid destination is another blood vein of the subject.
48. The method of any of paragraphs 42-47, wherein the subject is suffering from a pathogen-causing blood disease or disorder.
49. The method of paragraph 48, wherein the pathogen-causing blood disease or disorder is sepsis.
50. The method of paragraph 48 or 49, wherein the species-targeting magnetic particles comprise pathogen-targeting magnetic particles.
51. The method of paragraph 50, wherein the pathogen-targeting magnetic particles comprise FcMBL-coated magnetic particles.
52. A system for removing a target species from a fluid source comprising:
   i. a reciprocating fluid cleansing device, comprising:
      a first processing chamber including a port at a first end for fluid passage and a first movable plunger disposed at a second end, wherein the first movable plunger is configured to be in contact with a fluid; and wherein motion of the first movable plunger in a first direction is configured to transfer a first volume of the fluid from the fluid source into the first processing chamber; and motion of the first movable plunger in a second direction is configured to transfer the first volume of the fluid from the first processing chamber to a fluid destination;
   ii. a mixer device for mixing the fluid with species-targeting magnetic particles and/or species-targeting molecules, the mixer device being configured to connect between the fluid source and the first processing chamber; and
   iii. a first connector configured to connect the port of the first processing chamber to the fluid source and the fluid destination.
53. The system of paragraph 52, wherein the mixer device includes a spiral mixer.
54. The system of paragraph 52 or 53, wherein the mixer device has on its surface the species-targeting molecules.
55. The system of any of paragraphs 52-54, wherein the species-targeting magnetic particles are added to the fluid.
56. The system of any of paragraphs 52-55, wherein the first movable plunger in contact with the fluid further includes a motorized mixing element for mixing the fluid with the species-targeting magnetic particles.
57. The system of any of paragraphs 52-56, wherein the reciprocating fluid cleansing device further comprises at least one magnetic element for providing a magnetic field gradient within the first processing chamber.
58. The system of any of paragraphs 52-57, wherein the reciprocating fluid cleansing device further comprises:
   a second processing chamber, wherein the second processing chamber includes a port at a first end for fluid passage and a second movable plunger disposed at a second end, wherein the second movable plunger is mechanically coupled to the first movable plunger such that the motion of the first movable plunger in the first direction transfers the first volume of the fluid from the fluid source into the first processing chamber and simultaneously transfers a second volume of a fluid from the second processing chamber to the fluid destination; and the motion of the first movable plunger in the second direction transfers the first volume of the fluid from the first processing chamber to the fluid destination and simultaneously transfers a third volume of the fluid from the fluid source into the second processing chamber.
59. The system of paragraph 58, further comprising a second mixer device for mixing the fluid with the species-targeting magnetic particles and/or species-targeting molecules, the mixer device being configured to connect between the fluid source and the second processing chamber.
60. The system of paragraph 58 or 59, further comprising a second connector connecting the port of the second processing chamber to the fluid source and the fluid destination.
61. The system of any of paragraphs 58-60, wherein the second movable plunger in contact with a fluid includes a second motorized mixing element for mixing the fluid with the species-targeting magnetic particles.
62. The system of any of paragraphs 58-61, wherein the reciprocating fluid cleansing device further comprises at least one magnetic element for providing a magnetic field gradient within the second processing chamber.
63. The system of any of paragraphs 52-62, wherein the species-targeting magnetic particles are magnetic particles that adapted to be capable of binding or capturing the target species to be removed from the fluid.
64. The system of any of paragraphs 57-63, wherein the magnetic field gradient within the processing chamber is adjustable.
65. The system of any of paragraphs 52-64, further comprising at least one detection module for detecting the target species in the fluid transferred from the fluid source or to the fluid destination.
66. The system of any of paragraphs 52-65, further comprising a supply chamber periodically supplying the fluid from the fluid source, prior to flowing through the mixer device, with a plurality of fresh species-targeting magnetic particles.
67. The system of paragraph 66, wherein the detection module sends a signal to the supply chamber to release specific species-targeting magnetic particles.
68. The system of any of paragraphs 52-67, wherein the species-targeting magnetic particles comprise at least a fraction of mannose-binding lectin (MBL).
69. The system of any of paragraphs 57-68, wherein said at least one magnetic element is disposed in at least one of the first processing chamber and the second processing chamber.
70. The system of paragraph 57-69, wherein said at least one magnetic element is integrated with the movable plunger or the motorized mixing element.
71. The system of paragraph 70, wherein the movable plunger or the motorized mixing element becomes capable of providing the magnetic field gradient within at least one of the first processing chamber and the second processing chamber.
72. The system of paragraph 71, wherein said at least one magnetic element is adapted to be capable of moving in and out of at least one of the first processing chamber and the second processing chamber.
73. The system of any of paragraphs 57-69, wherein said at least one magnetic element is placed around an exterior surface of at least one of the first processing chamber and the second processing chamber.
74. The system of any of paragraphs 57-73, wherein said at least one magnetic element is selected from a group consisting of a permanent magnet, an electromagnet, a magnetizable material, and any combinations thereof.
75. The system of any of paragraphs 56-74, wherein the motorized mixing element comprises an impeller.
76. The system of paragraph 75, wherein the impeller is configured for low-shear mixing.
77. The system of any of paragraphs 56-74, wherein the motorized mixing element comprises a flexible strip of a fluid-compatible material that extends and collapses freely to mix along the length of the processing chamber.
78. The system of any of paragraphs 52-77, wherein at least one the first movable plunger and the second movable plunger further comprises a tachometer wheel, a switch, a potentiometer speed dial, a battery or any combinations thereof.
79. The system of any of paragraphs 52-78, further comprising at least one catheter connecting the port to the fluid source and the fluid destination.
80. A method for removing a target species from a fluid source, comprising:
   i. providing a system of any of paragraphs 52-79;
   ii. transferring, in the absence of a first magnetic field gradient, a first volume of a fluid from the fluid source and a first plurality of species-targeting magnetic particles through the mixer device into the first processing chamber; wherein the mixer device is activated to mix the first volume of the fluid with the first plurality of species-targeting magnetic particles, wherein at least a portion of the first plurality of the species targeting magnetic particles bind to the target species present in the first volume of the fluid;
   iii. activating the magnetic element of the first processing chamber to generate the first magnetic field gradient for separating the first plurality of the species-targeting magnetic particles from the first volume of the fluid to yield a first magnetic particle-free fluid; and
   iv. transferring, in the presence of the first magnetic field gradient, the first magnetic particle-free fluid to the fluid destination; thereby removing the target species from the first volume of the fluid.
81. A method for removing a target species from a fluid source, comprising:
   i. providing a system of any of paragraphs 54-79; wherein the mixer device comprises on its surface species-targeting molecules;
   ii. transferring a first volume of a fluid from the fluid source through the mixer device into the first processing chamber; wherein the mixer device is activated to mix the first volume of the fluid with the species-targeting molecules, and wherein the target species present in the first volume of the fluid binds to at least a portion of the species targeting molecules; thereby generating a first cleansed fluid;
   iii. transferring the first cleansed fluid to the fluid destination; thereby removing the target species from the first volume of the fluid.
82. The method of paragraph 80 or 81, further comprising transferring a second volume of the fluid from the fluid source through a second mixer device into a second processing chamber, wherein the second mixer device is activated to mix the second volume of the fluid with a second plurality of species-targeting magnetic particles and/or species-targeting molecules, wherein at least a portion of the second plurality of the species targeting magnetic particles and/or species-targeting molecules bind to the target species present in the second volume of the fluid.
83. The method of paragraph 82, further comprising activating a magnetic element of the second processing chamber to generate a second magnetic field gradient for separating the second plurality of the species-targeting magnetic particles from the second volume of the fluid to yield a second magnetic particle-free fluid, thereby removing the target species from the second volume of the fluid.
84. The method of any of paragraphs 80-83, further comprising adding the first plurality of the species-targeting magnetic particles to the first volume of the fluid, prior to the first volume of the fluid flowing through the mixer device.
85. The method of any of paragraphs 82-84, further comprising adding the second plurality of the species-targeting magnetic particles to the second volume of the fluid, prior to the second volume of the fluid flowing through the second mixer device.
86. The method of any of paragraphs 80-85, wherein the fluid source is a blood vein of a subject.
87. The method of any of paragraphs 80-86, wherein the fluid destination is another blood vein of the subject.
88. The method of any of paragraphs 86-87, wherein the subject is suffering from a pathogen-causing blood disease or disorder.
89. The method of paragraph 88, wherein the pathogen-causing blood disease or disorder is sepsis.
90. The method of paragraph 88 or 89, wherein the species-targeting magnetic particles comprise pathogen-targeting magnetic particles.
91. The method of paragraph 90, wherein the pathogen-targeting magnetic particles comprise FcMBL-coated magnetic particles.

Each of these embodiments and obvious variations thereof is contemplated as falling within the spirit and scope of the claimed invention, which is set forth in the following claims.

What is claimed is:

1. A system for removing a target species from a fluid source comprising:
i. a reciprocating fluid cleansing device, comprising:
(i) a first processing chamber including a port at a first end for fluid passage and a first movable plunger disposed at a second end, wherein the first movable plunger is configured to be in contact with a fluid and includes a motorized mixing element for mixing the fluid with species-targeting magnetic particles; and wherein motion of the first movable plunger in a first direction is configured to transfer a first volume of the fluid from the fluid source into the first processing chamber; and motion of the first movable plunger in a second direction is configured to transfer the first volume of the fluid from the first processing chamber to a fluid destination; and
(ii) at least one magnetic element for providing a magnetic field within the first processing chamber, and
ii. a first connector configured to connect the port of the first processing chamber to the fluid source and the fluid destination.

2. The system of claim 1, wherein the reciprocating fluid cleansing device further comprises:
(i) a second processing chamber, wherein the second processing chamber includes a port at a first end for fluid passage and a second movable plunger disposed at a second end, wherein the second movable plunger is mechanically coupled to the first movable plunger such that the motion of the first movable plunger in the first direction transfers the first volume of the fluid from the fluid source into the first processing chamber and simultaneously transfers a second volume of a fluid from the second processing chamber to the fluid destination; and the motion of the first movable plunger in the second direction transfers the first volume of the fluid from the first processing chamber to the fluid destination and simultaneously transfers a third volume of the fluid from the fluid source into the second processing chamber; and
(ii) at least one magnetic element for providing a magnetic field within the second processing chamber.

3. The system of claim 2, further comprising a second connector connecting the port of the second processing chamber to the fluid source and the fluid destination.

4. The system of claim 2, wherein the second movable plunger in contact with a fluid includes a motorized mixing element for mixing the fluid with species-targeting magnetic particles.

5. The system of claim 1, wherein the magnetic field within the processing chamber is adjustable.

6. The system of claim 1, further comprising at least one detection module for detecting the target species in the fluid transferred from the fluid source or to the fluid destination.

7. The system of claim 1, wherein at least one of the first processing chamber, and the second processing chamber is pre-loaded with a plurality of the species-targeting magnetic particles.

8. The system of claim 1, further comprising a supply chamber periodically supplying the fluid from the fluid source, prior to entering the first or the second processing chamber, with a plurality of fresh species-targeting magnetic particles.

9. The system of claim 8, wherein the detection module sends a signal to the supply chamber to release specific species-targeting magnetic particles.

10. The system of claim 1, wherein the species-targeting magnetic particles comprise at least a fraction of mannose-binding lectin (MBL).

11. The system of claim 2, wherein said at least one magnetic element is disposed in at least one of the first processing chamber and the second processing chamber.

12. The system of claim 11, wherein said at least one magnetic element is integrated with the motorized mixing element.

13. The system of claim 12, wherein the motorized mixing element becomes capable of providing the magnetic field within at least one of the first processing chamber and the second chamber.

14. The system of claim 11, wherein said at least one magnetic element is adapted to be capable of moving in and out of at least one of the first processing chamber and the second processing chamber.

15. The system of claim 1, wherein said at least one magnetic element is placed around an exterior surface of at least one of the first processing chamber and the second processing chamber.

16. The system of claim 1, wherein said at least one magnetic element is selected from a group consisting of a permanent magnet, an electromagnet, a magnetizable material, and any combinations thereof.

17. The system of claim 1, wherein the motorized mixing element is an impeller.

18. The system of claim 17, wherein the impeller is configured for low-shear mixing.

19. The system of claim 1, wherein the motorized mixing element is a flexible strip of a fluid-compatible material that extends and collapses freely to mix along the length of the processing chamber.

20. The system of claim 2, wherein at least one the first movable plunger and the second movable plunger further comprises a tachometer wheel, a switch, a potentiometer speed dial, a battery or any combinations thereof.
